(19) United States
(12) Patent Application Publication
(10) Pub. No.: US 2026/0156677 A1
(43) Pub. Date: Jun. 4, 2026

(54) LOW LATENCY ENERGY DETECTION IN A WIRELESS COMMUNICATION NETWORK

(71) Applicant: Morse Micro Pty. Ltd., Surry Hills NSW (AU)

(72) Inventor: Surendra Raju Meesaraganda, Bangalore (IN)

(21) Appl. No.: 19/352,709

(22) Filed: Oct. 8, 2025

(30) Foreign Application Priority Data
Nov. 29, 2024 (AU) 2024903944

(51) Int. Cl. H04W 74/0816; H04B 17/318; H04L 25/02; H04W 52/52

(52) U.S. Cl. CPC H04W 74/0816; H04B 17/318; H04L 25/0212; H04W 52/52

(57) ABSTRACT

Systems and techniques are provided for energy detection by a wireless communication device. A method includes filtering a received signal using a half-band (HB) filter with a configured cut-off frequency to obtain a filtered signal based on the received signal, wherein the HB filter is associated with a receiver of the wireless communication device, and the received signal comprises a wireless transmission received by the receiver. Information indicative of a power level can be determined corresponding to a detected energy associated with the filtered signal. Embodiments of the wireless communication device process the received signal according to the information indicative of the power level, before demodulated symbols become available from a receiver downsampling chain.

### CROSS-REFERENCE TO RELATED APPLICATIONS

This application claims the benefit of Australian Provisional Patent Application No. 2024903944, filed on Nov. 29, 2024, which is hereby incorporated by reference, in its entirety and for all purposes.

### FIELD

The present disclosure generally relates to wireless communications. For example, aspects of the present disclosure are related to systems and techniques for low latency energy detection on a wireless medium and/or in a wireless communication network, using an energy detection path in parallel with a modulation or demodulation path.

### BACKGROUND

Energy detection is an example of a spectrum sensing technique which may be used in wireless communication systems and network. For example, energy detection can be used to determine the presence or absence of a signal within a given frequency band (e.g., a frequency band for which the energy detection is performed). In some examples, wireless communication devices with energy detection capabilities can be configured to measure the received wireless signal power in a target frequency band, and compare the measured power (e.g., detected and/or measured energy) against one or more thresholds. For instance, the wireless communication device can infer (e.g., determine, etc.) that a channel or target frequency band is occupied based on the measured energy exceeds a threshold. The wireless communication device may infer that the channel or target frequency band is unoccupied (e.g., free) based on the measured energy being below the threshold. Energy detection and/or energy detection-based spectrum sensing techniques may be particularly prevalent in wireless communication networks operating under dynamic spectrum access paradigms, such as cognitive radio systems, where devices must identify unused spectrum to minimize interference. For example, wireless communication devices may be configured to execute energy detection before transmission, with the transmission performed in response to a successful energy detection result indicating the channel or target frequency band is not occupied or otherwise has an energy detection result below a threshold.

Energy detection is also used in standards such as the Institute of Electrical and Electronics Engineers (IEEE) 802.11, Wi-Fi, and IEEE 802.15.4, IoT and low power networks, for channel access decisions and collision avoidance in shared spectrum environments. For example, various energy detection techniques can be used for sensing spectrum occupancy in shared bands implemented according to one or more standards. Various energy detection techniques may exhibit sensitivities to noise uncertainty that can cause performance degradation in relatively low signal-to-noise ratio (SNR) conditions and environments, as well as in the presence of interference, etc. For example, noise uncertainty, low SNR, and/or interference can decrease the accuracy of the energy measurement or estimation that is determined by a wireless communication device and compared to the one or more thresholds for determining whether a channel or target frequency band is busy (e.g., occupied) or idle (e.g., unoccupied, free, etc.). Effective energy detection can be essential for ensuring efficient spectrum usage, reducing collisions, and maintaining compliance with regulatory requirements for coexistence in shared or unlicensed bands. Optimizing energy detection algorithms is an ongoing research area to support reliable and scalable wireless communications.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for energy detection by a wireless device. In an illustrative example, a method for energy detection by a wireless communication device is provided, the method comprising filtering a received signal using a half-band (HB) filter with a configured cut-off frequency to thereby obtain a filtered signal based on the received signal, wherein the HB filter is associated with a receiver of the wireless communication device, and the received signal comprises a wireless transmission received by the receiver; determining information indicative of a power level corresponding to a detected energy associated with the filtered signal; and processing, by the wireless communication device, the received signal according to the information indicative of the power level.

In some aspects, the receiver of the wireless communication device is associated with a receiver downsampling chain comprising a first signal processing path, and the HB filter is included in a second signal processing path different from the first signal processing path and in parallel with at least a portion of the receiver downsampling chain.

In some aspects, processing the received signal comprises processing one or more receiver functions based on the information indicative of the power level before demodulated symbols become available from the receiver downsampling chain.

In some aspects, processing the receiver functions includes performing clear channel assessment (CCA) based on the information indicative of the power level.

In some aspects, the second signal processing path comprises an energy detection branch tapped from an output of a compensation filter included in the receiver downsampling chain.

In some aspects, the energy detection branch is in parallel with a receiver decimation chain included in the receiver downsampling chain after the output of the compensation filter.

In some aspects, an input to the second signal processing path corresponds to an output of a compensation filter included in the first signal processing path.

In some aspects, a first portion of the receiver downsampling chain is before an output of a compensation filter; a second portion of the receiver downsampling chain is after the output of the compensation filter; and the second signal processing path is in parallel with the second portion of the receiver downsampling chain.

In some aspects, the HB filter is associated with a first group delay, and the first group delay is less than a second group delay associated with the second portion of the receiver downsampling chain.

In some aspects, the HB filter is an Infinite Impulse Response (IIR) HB filter, and an input to the HB filter corresponds to an output of a compensation filter included a receiver downsampling chain of the wireless communication device.

In some aspects, the IIR HB filter comprises two or more all-pass filter sections with respective configurable parameters based on an attenuation characteristic.

In some aspects, each all-pass filter section of the two or more all-pass filter sections is associated with a respective input, and the respective input for each all-pass filter section is configured to share a common delay register included in the receiver.

In some aspects, determining information indicative of the power level comprises calculating an energy metric based on an output of the HB filter corresponding to the filtered signal by applying a magnitude approximation and an averaging filter to the filtered signal output of the HB filter; and calculating the energy metric from an averaged output from the averaging filter.

In some aspects, the averaging filter comprises an exponential averaging filter implemented by a single pole Infinite Impulse Response (IIR) filter; or one or a combination of an exponential averaging filter and a moving window averaging filter.

In some aspects, the power level is a measure of in-band energy corresponding the received signal, and processing the received signal according to the information indicative of the power level comprises at least one of performing a gating automatic gain control (AGC) reset operation in response to the power level being below a configured threshold; or performing gating packet detection to avoid false alarms on interferences in response to the power level being below the configured threshold.

In some aspects, the power level is a measure of an out-of-band or out-of-channel energy associated with at least one of the received signal or the wireless transmission.

In some aspects, the HB filter is a programmable filter configurable between a low-pass filter configuration and a high-pass filter configuration; the power level is a measure of in-band energy of the received signal based on the HB filter having the low-pass filter configuration; and the power level is a measure of an out-of-band energy associated with the received signal based on the HB filter having the a high-pass filter configuration.

In some aspects, the method further comprises applying a low-pass to low-pass transformation to transform a delay element of an original transfer function of the HB filter to obtain a new all-pass filter section corresponding to a transformed filter function, and the configured cut-off frequency of the HB filter is determined based on the transformed filter function.

In some aspects, applying the low-pass to low-pass transformation of the HB filter is based on determining corresponding transformation approximation information, and the corresponding transformation approximation information is used to derive a modified transfer function with a reduced number of all-pass filter sections.

In another illustrative example, provided is wireless communication device in a wireless communication network, the wireless device comprising a receiver configured to obtain a received signal corresponding to a wireless transmission over the wireless communication network, wherein the receiver includes a receiver downsampling chain configured to perform downsampling of the received signal; a half-band (HB) filter having a configured cut-off frequency and included in an energy detection branch tapped from an output of a compensation filter of the receiver downsampling chain, wherein the HB filter generates a filtered signal from the output of the compensation filter in parallel with a remaining portion of the receiver downsampling chain after the compensation filter; an energy meter configured to determine a power level corresponding to the filtered signal obtained from an output of the HB filter; and a processing module configured to process the received signal according to the power level.

In some aspects, to process the received signal, the processing module is configured to process one or more receiver functions based on the detected power level, wherein the receiver functions are processed before demodulated symbols become available from the receiver downsampling chain.

In some aspects, an input of the HB filter is coupled to the output of the compensation filter of the receiver downsampling chain.

In some aspects, the wireless device further comprises a digital high pass filter coupled to the output of the compensation filter and the input of the HB filter, wherein the digital high pass filter is configured to remove DC signal components from the output of the compensation filter and provide the DC filtered signal to the input of the HB filter.

In some aspects, the energy meter includes a magnitude approximation module coupled to an output of the HB filter and configured to determine a measured magnitude, and the energy meter further includes an averaging filter configured to compute the power level based on the measured magnitude.

In some aspects, the energy meter is configured to determine the power level using an in-band power computation configured to convert the power level from decibel (dB) to an input referred power level in decibel-milliwatts (dBm).

In some aspects, the processing module is configured to process the received signal by gating and resetting an automatic gain control (AGC) gated adaptively according to the power level determined by the energy meter.

In some aspects, the processing module comprises a packet detection module, and the packet detection module is adaptively gated according to the power level determined by the energy meter.

In some aspects, the processing module comprises a medium access control (MAC) processor, and wherein the power level is used to perform a clear channel assessment (CCA) for reporting by the wireless device.

In some aspects, the processing module comprises an automatic gain control (AGC) wherein a gain of the AGC is adjusted according to the power level determined by the energy meter.

In some aspects, the HB filter is a programmable cut-off Infinite Impulse Response (IIR) filter having a low-pass to low-pass transformation, and the configured cut-off frequency of the HB filter is determined based on a transformed filter function of the low-pass to low-pass transformation.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following drawing figures:

FIG. 1 is a block diagram illustrating an exemplary wireless communication network;

FIG. 2A is a block diagram of a wireless communication device that can implement a station (STA) or access point (AP), in accordance with some embodiments;

FIG. 2B is a schematic block diagram of the receiver data flow architecture of the wireless communication device of FIG. 2A, in accordance with some embodiments;

FIG. 2C is a schematic block diagram of a transmitter data flow architecture that can be used to transmit Radio Frequency (RF) signals over a wireless medium, in accordance with some embodiments;

FIG. 3A is a diagram illustrating an example of an infinite impulse response (IIR) half-band (HB) filter including first and second all-pass filter sections, in accordance with some embodiments;

FIG. 3B is a diagram illustrating an example structure of an all-pass filter section, which may be used to implement one or more of the all-pass filter sections of the IIR HB filter of FIG. 3A, in accordance with some embodiments;

FIG. 4A is a diagram illustrating an example graph of phase responses corresponding to first and second all-pass filter sections, in accordance with some embodiments;

FIG. 4B is a diagram illustrating an example graph of the magnitude response of an IIR HB filter, in accordance with some embodiments;

FIG. 5 is a diagram illustrating an example graph of a pole-zero configuration of an IIR HB filter, in accordance with some embodiments;

FIG. 6 is a diagram illustrating an example graph of a group delay response for an IIR HB filter, in accordance with some embodiments;

FIGS. 7A-7C are diagrams illustrating example fixed-point implementations of an IIR HB filter using all-pass filter sections, in accordance with some embodiments;

FIG. 8 is a diagram illustrating an example of a fixed-point implementation of an IIR HB filter using all-pass filter sections and with a reduced delay register, in accordance with some embodiments;

FIG. 9 is a diagram illustrating an example of a receiver downsampling chain configured to receive a signal from an analog-to-digital (ADC) converter and output a processed signal to a baseband module, in accordance with some embodiments;

FIG. 10 is a diagram illustrating an example of an energy meter configured to generate an in-band energy measurement, in accordance with some embodiments;

FIG. 11 is a diagram illustrating an example of an energy meter implementation configured to determine in-band energy information (e.g., power level) on a decibel (dB) scale, in accordance with some embodiments;

FIG. 12 is a diagram illustrating an example of respective latencies observed at various stages within the receiver downsampling chain, in accordance with some embodiments;

FIG. 13 is a diagram illustrating an example of an averaging filter implemented as a moving window averaging filter, in accordance with some embodiments;

FIG. 14 is a diagram illustrating an example graph of rise times corresponding to a moving averaging filter and an exponential averaging filter, in accordance with some embodiments;

FIG. 15 is a diagram illustrating an example of power level conversion from a dB representation to an input-referred level in dBm, in accordance with some embodiments;

FIG. 16 is a diagram illustrating an example filter implementation with a modified transfer function with four all-pass filter sections configured with varying values of a first and second parameter, in accordance with some embodiments;

FIG. 17 is a block diagram illustrating an example implementation of a group delay element for the filter of FIG. 16, in accordance with some embodiments;

FIG. 18 is a diagram illustrating an example fixed-point implementation of a delay element, in accordance with some embodiments;

FIG. 19 is a diagram illustrating an example fixed-point implementation of a programmable cut-off IIR filter, in accordance with some embodiments; and

FIG. 20 is a block diagram illustrating an example of a computing system for implementing certain aspects described herein, in accordance with some embodiments.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

### Overview

Aspects of the present invention can be used to provide novel and effective systems and techniques of energy detection for a wireless communication device operating in a wireless communications network. For example, aspects of the present invention can be used by a wireless receiver to derive early and reliable energy measurements by tapping a parallel, low-latency signal path after a compensation filter in a demodulation chain, and filtering the parallel path with a multi-section all-pass half-band filter having a group delay that is substantially smaller than that of the demodulation chain. The output of the parallel, low-latency signal path can be provided to an energy meter configured to perform energy detection for the wireless communication device (e.g., the wireless receiver). For example, the energy meter and/or energy detection technique can use a multiplier-less magnitude approximation with configurable averaging based on an exponential or moving window to obtain the energy detection result with a reduced latency compared to performing energy detection in or on the demodulation chain (e.g., reduced latency relative to energy detection without the parallel, low-latency signal path described herein, etc.).

In some embodiments, an energy detection method can include receiving a wireless signal, filtering the wireless signal by a half-band (HB) filter with a predetermined cut-off frequency, detecting a power level of the filtered wireless signal, and processing the wireless signal according to the detected power level. In some embodiments, the HB filter is an Infinite Impulse Response (IIR) HB filter provided at an output of a compensation filter in a receiver downsampling chain. The IIR HB filter can include two or more all-pass filter sections with respective configurable parameters for each one of the all-pass filter sections to thereby achieve an attenuation characteristic. For example, each of the parameters configured for the all-pass filter sections may be a power of two. In some cases, inputs of the two or more all-pass filter sections can be configured to share one delay register, and the IIR HB filter can be implemented with a low group delay in the receiver downsampling chain. In some embodiments, a predetermined cut-off frequency of the HB filter is at ¼ of the sampling frequency to reject out-of-band energy above the predetermined cut-off frequency. In some embodiments, the energy detection method further comprises passing the filtered wireless signal through a magnitude approximation and an averaging filter to generate the power level. In some embodiments, the averaging filter includes one or more of an exponential averaging filter and a moving window averaging filter. For example, the average filter is an exponential averaging filter implemented by a single pole IIR filter. An embodiment of the energy detection method passes the wireless signal through a digital high pass filter (HPF) before filtering by the HB filter. The energy detection method further converts the power level in dB to input referred power level in dBm.

In some embodiments, the power level is a measure of in-band energy. The step of processing the wireless signal may include one or a combination of gating automatic gain control (AGC) operation to reset AGC when the detected power level is below a threshold, gating packet detection to avoid false alarms on interference when the detected power level is below a threshold, performing clear channel assessment (CCA) using the detected power level. In some other embodiments, the power level is a measure of an out-of-band or out-of-channel energy. The HB filter may be configurable for detecting in-band energy or out-of-band energy, for example, the power level is a measure of the in-band energy when the HB filter is configured to a low pass filter and the power level is a measure of the out-of-band energy when the HB filter is configured to a high pass filter. Some embodiments of the energy detection method utilize a programmable cut-off IIR filter to modify the predetermined cut-off frequency. The energy detection method further comprises applying a low-pass to low-pass transformation to transform a delay element of an original transfer function of the HB filter to a new all-pass section to obtain a transformed filter function, where the cut-off frequency of the HB is determined based on the transformed filter function. The low-pass to low-pass transformation of the HB filter may be simplified by approximating the transformation to derive a modified transfer function with a reduced number of all-pass filter sections. This programmable cut-off IIR filter with the low-pass to low-pass transformation may be used in the transmitter upsampling chain according to some other embodiments.

Another aspect of the present invention presents a wireless communication device operating in a wireless communication network, the wireless communication device includes a receiver downsampling chain receiving and downsampling a wireless signal, a HB filter filtering the wireless signal with a predetermined cut-off frequency, an energy meter detecting a power level of the filtered wireless signal output from the HB filter, and a processing module processing the wireless signal according to the detected power level. The receiver downsampling chain includes a compensation filter coupled to an input of the HB filter according to an embodiment. In one embodiment, a digital high pass filter is coupled to an output of the compensation filter and the input of the HB filter. The energy meter includes a magnitude approximation coupled to an output of the HB filter to measure the magnitude of the power level, and an averaging filter for power level computation. In an embodiment, an in-band power computation is coupled with the energy meter for converting the power level in dB to input referred power level in dBm. Some embodiments of the processing module comprise an AGC, a packet detection module, a medium access control (MAC) processor, or a combination thereof. The AGC can be gated and reset adaptively according to the power level detected by the energy meter. In another example, the detected power level assists the AGC by providing a way to measure signal strength in real time, even for weaker signals below an analog received signal strength indicator (RSSI) threshold. The packet detection module can be adaptively gated according to the detected power level. The detected power level can be used to perform a CCA and report to the MAC processor.

### Example Embodiments

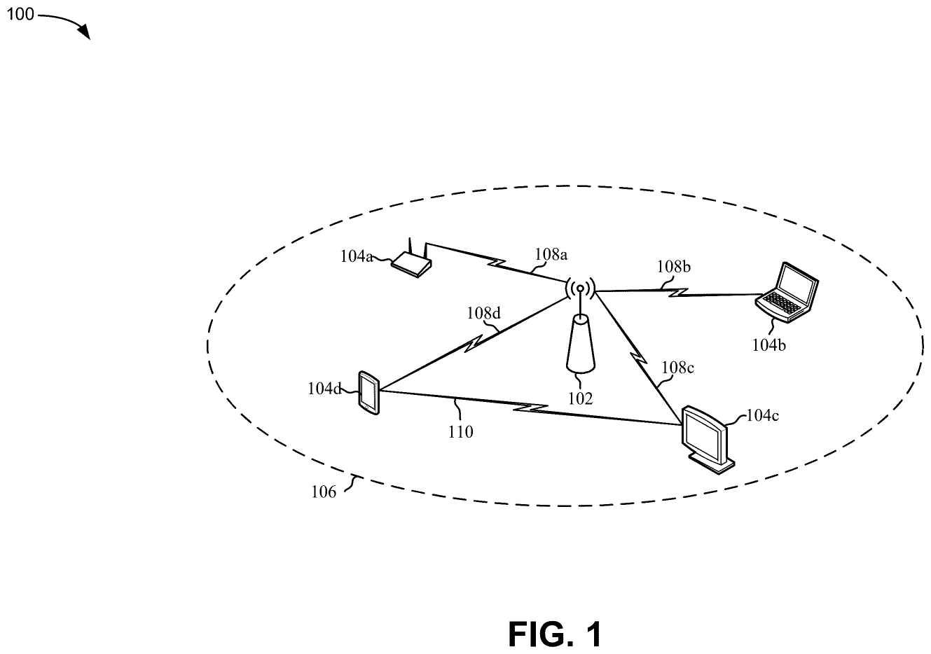

FIG. 1 is a block diagram illustrating an exemplary wireless communication network 100. In some aspects, the wireless communication network 100 can be an example of a Wireless Local Area Network (WLAN). As used herein, a WLAN may be a Wi-Fi network. In some examples, the WLAN 100 can be a network implementing at least one of the IEEE 802.11 family of wireless communication protocol standards (e.g., such as that defined by the IEEE 802.11-2020 specification or amendments thereof including, but not limited to, 802.11ah, 802.11ay, 802.11ax, 802.11az, 802.11ba and 802.11be). The WLAN 100 may include at least one AP 102 and multiple associated STAs 104. For example, the STAs 104 can include a first STA 104a, a second STA 104b, a third STA 104c, a fourth STA 104d, etc. While only one AP 102 is shown, the WLAN network 100 also can include multiple APs 102.

Each of the STAs 104a-104d may be referred to as a Mobile Station (MS), a mobile device, a mobile handset, a wireless handset, an Access Terminal (AT), a User Equipment (UE), a Subscriber Station (SS), and/or a subscriber unit, among other examples. The STAs 104 may represent various devices such as mobile phones, handheld devices, netbooks, computers, tablet computers, laptops, display devices (e.g., TVs, computer monitors, navigation systems, etc.), music or other audio or stereo devices, remote control devices (“remotes”), printers, kitchen or other household appliances, key fobs (e.g., for Passive Keyless Entry and Start (PKES) systems), etc.

A single AP 102 and an associated set of STAs 104a-104d may be referred to as a Basic Service Set (BSS), which is managed by the respective AP 102. FIG. 1 additionally shows an example coverage area 106 of the AP 102, which may represent a Basic Service Area (BSA) of the WLAN 100. The BSS may be identified to users by a Service Set Identifier (SSID), as well as to other devices by a Basic Service Set Identifier (BSSID), which may be a Medium Access Control (MAC) address of the AP 102.

The AP 102 periodically broadcasts beacon frames (“beacons”) including the BSSID to enable any STAs (e.g., such as one or more, or all, of the STAs 104a-104d) within wireless range of the AP 102 to associate or re-associate with the AP 102 to establish a respective communication link 108a-108d (e.g., hereinafter also referred to as a “Wi-Fi link”). For example, the first STA 104a can establish a respective communication link 108a with the AP 102, the second STA 104b can establish a respective communication link 108b with the AP 102, the third STA 104c can establish a respective communication link 108c with the AP 102, the fourth STA 104d can establish a respective communication link 108d with the AP 102, etc. The STAs 104a-104d may additionally use the beacon frames broadcast by AP 102 to maintain the respective communication link 108a-108d with the AP 102. For example, the beacons can include an identification of a primary channel used by the respective AP 102 as well as a timing synchronization function for establishing or maintaining timing synchronization with the AP 102. The AP 102 may provide access to external networks to various STAs in the WLAN via respective communication links 108.

To establish the communication links 108a-108d with an AP 102, each of the respective STAs 104a-104d can perform passive or active scanning operations (“scans”) on frequency channels in one or more frequency bands. For example, to perform passive scanning, each of the STAs 104a-104d listens for beacons that are transmitted by the AP 102 at a periodic time interval referred to as the Target Beacon Transmission Time (TBTT). The TBTT can be measured in Time Units (TUs). In some examples, one TU may be equal to 1024 microseconds (μs). In some examples, the TBTT can have a default value of 102.4 milliseconds (ms). To perform active scanning, each of the STAs 104a-104d can generate and sequentially transmit probe requests on each channel to be scanned and listens for probe responses from the AP 102. Each of the STAs 104a-104d may be configured to identify or select an AP 102 with which to associate (e.g., based on the scanning information obtained through the passive or active scans), and to perform authentication and association operations to establish a respective communication link 108a-108d with the selected AP 102. The AP 102 assigns an Association Identifier (AID) to each of the STAs 104a-104d at the culmination of the association operations, which the AP 102 uses to track the STAs 104a-104d.

In some cases, one or more of the STAs 104a-104d may have the opportunity to select one of many BSSs within range of the STA or to select among multiple APs 102 that together form an Extended Service Set (ESS) including multiple connected BSSs. An extended network station associated with the WLAN 100 may be connected to a wired or wireless distribution system that may allow multiple APs 102 to be connected in an ESS. In some examples, one or more of the STAs 104a-104d can be covered by more than one AP 102 and can associate with different APs 102 at different times for transmissions. After association with an AP 102, one or more of the STAs 104a-104d also may be configured to periodically scan its surroundings to find a more suitable AP with which to associate. For example, a given one of the STAs 104a-104d that is moving away from its associated AP 102 may perform a “roaming” scan to find another AP having more desirable network characteristics (e.g., such as a greater Received Signal Strength Indicator (RSSI), a reduced traffic load, etc.).

In some cases, the STAs 104a-104d may form networks without APs 102 or other equipment other than the STAs 104a-104d themselves. One example of such a network is an ad hoc network. Some examples of an ad hoc network are mesh networks and peer-to-peer (P2P) networks. In some cases, ad hoc networks may be implemented within a larger wireless network. In such implementations, while the STAs 104a-104d may be capable of communicating with each other through the AP 102 using the respective communication links 108a-108d, the STAs 104a-104d, the STAs may also communicate directly with each other using direct wireless links 110. In some examples, two STAs may communicate via a direct communication link 110 regardless of whether both STAs 104 are associated with and served by the same AP 102. In such an ad hoc system, one or more of the STAs 104a-104d may assume the role filled by the AP 102 in a BSS. Such a STA may be referred to as a Group Owner (GO) and may coordinate transmissions within the ad hoc network. Examples of direct wireless links 110 can include one or more of Wi-Fi Direct connections, connections established by using a Wi-Fi Tunneled Direct Link Setup (TDLS) link, and other P2P group connections, etc.

The APs 102 and STAs 104a-104d may function and communicate using the respective communication links 108a-108d according to at least one of the IEEE 802.11 wireless communication protocol standards. These standards define the WLAN radio and baseband protocols for the physical (PHY) and Medium Access Control (MAC) layers. For example, the APs 102 and STAs 104a-104d transmit and receive wireless communications to and from one another in the form of PHY Protocol Data Units (PPDUs) or Physical Layer Convergence Protocol (PLCP) PDUs. The APs 102 and STAs 104a-104d in the WLAN 100 may transmit PPDUs over a license or unlicensed spectrum, which may be a portion of spectrum that includes frequency bands traditionally used by Wi-Fi technology, such as the 2.4 GHz band, the 5 GHz band, the 60 GHz band, the 3.6 GHz band, and the sub-1 GHz band. Some implementations of the APs 102 and STAs 104a-104d described herein also may communicate in other frequency bands, such as the 6 GHz band, which may support both licensed and unlicensed communications. The APs 102 and STAs 104a-104d also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11 standards and specifications may be transmitted over frequency bands that are divided into multiple 20 MHz channels. In such examples, the PPDUs are transmitted over a physical channel having a minimum bandwidth of 20 MHz, although other channel bandwidths are also possible. In some cases, a larger bandwidth channel can be formed using channel bonding, which bonds together multiple channels each of the minimum bandwidth.

Each PPDU is a composite structure that includes a PHY preamble and a payload in the form of a PHY Service Data Unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

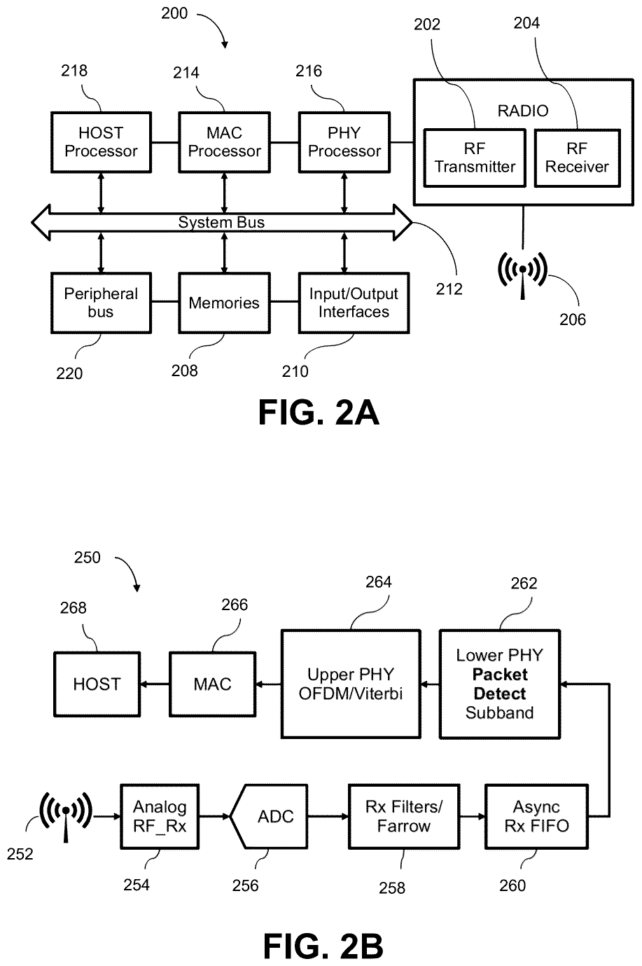

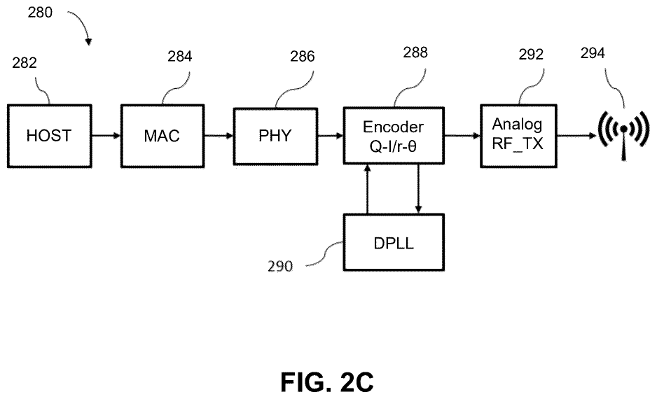

FIG. 2A is a high-level block diagram of an exemplary wireless communication device 200 that can be used to implement a STA or an AP, in some examples. The wireless communication device 200 can include a MAC layer and a PHY layer in accordance with one or more of the IEEE 802.11 standards.

The wireless communication device 200 includes a Radio Frequency (RF) transmitter module 202, an RF receiver module 204, an antenna unit 206, one or more memory banks 208, input and output interfaces 210, and communication bus 212. The RF transmitter module 202 and the RF receiver module 204 include a modem (modulator-demodulator device), which transmits data by modulating one or more carrier wave signals to encode digital information, as well as receives data by demodulating the signal to recreate the original digital information. As illustrated, the wireless communication device 200 further includes a MAC processor 214, a PHY processor 216 and a HOST processor 218. These processors can be any type of Integrated Circuit (IC) including a general processing unit, an Application Specific Integrated Circuit (ASIC) or Reduced Instruction Set Computer-Five (RISC-V) based ICs, amongst others.

The memory 208 can be used to store software and/or computer-readable instructions, including software or instructions that can be used to implement at least some functions of the MAC layer. For example, each processor included in the wireless communication device 200 (e.g., MAC processor 214, PHY processor 216, HOST processor 218, etc.) executes respective software to implement the functions of the respective communication/application layer.

The PHY processor 216 includes a transmitting signal processing unit and a receiving signal processing unit (not shown) and can be used to manage the interface with the Wireless Medium (WM). The PHY processor 216 operates on PPDUs by exchanging digital samples with the radio module which includes the RF transmitter 202, the RF receiver 204, analog-to-digital converters, and digital filters.

The MAC processor 214 executes MAC level instructions and manages the interface between the application software and the WM, through the PHY processor 216. The MAC processor 214 is responsible for coordinating access to the WM so that the Access Point (AP) and STAs in range can communicate effectively. The MAC processor 214 adds header and tail bytes to units of data provided by the higher levels and sends them to the PHY layer for transmission. The reverse happens when receiving data from the PHY layer. If a frame is received in error, the MAC processor 214 manages the retransmission of the frame.

The HOST processor 218 interfaces with the MAC layer and is responsible for running higher level functionalities of the wireless communication device.

The PHY processor 216, the MAC processor 214, the HOST processor 218, the peripheral bus 220, the memories 208, and the input/output interfaces 210 communicate with each other via the peripheral bus 212. The peripheral bus 220 connects to a number of peripherals that support core functions of the wireless communication device 200, including timers, interrupts, radio/filters/system registers, counters, UART, GPIO interfaces, among others. The memory 208 may further store an operating system and applications. In some examples, the memory may store recorded information about captured frames and packets. The input/output interface unit 210 allows for exchange of information with a user of the wireless communication device. The antenna unit 206 can include a single antenna and/or can include multiple antennas. For example, multiple antennas can be used to implement Multiple Input Multiple Output (MIMO) techniques, among others.

FIG. 2B illustrates a schematic block diagram of a receiver data flow architecture 250 that can be used to receive Wi-Fi packets over the network. In one illustrative example, the receiver data flow architecture 250 illustrated in FIG. 2B can correspond to or otherwise be associated with the wireless communication device 200 illustrated in FIG. 2A. Radio signals are received over the WM and translated into electrical signals by the receiving antenna 252 (e.g., which can be the same as or similar to antenna 206). The received signal is conditioned using a series of analog filters 254 (e.g., depicted as analog RF receive (Rx) filters) before being converted into a digital signal equivalent using an Analog-to-Digital Converter (ADC) 256. The sampled signal output of ADC 256 is conditioned again using a filter bank 258, which can include one or more digital RF filters and/or a farrow, before the samples are collected in an asynchronous receiving First-In-First-Out (FIFO) data structure 260.

Samples in FIFO structure 260 can be accessed by a plurality of modules. For example, samples can be accessed by a packet detect module and a sub-band module, both of which may be included in the lower-level PHY portion 262 depicted in FIG. 2B. In some embodiments, the lower-level PHY portion 262 is itself included in the PHY processor 216 illustrated in FIG. 2A.

The packet detect module included in the lower-level PHY portion 262 includes hardware and/or implement algorithms that is used to analyze the initial sections of the PPDU in the time domain. Based on the analysis, the packet detect module is used to recognize a received frame and synchronize frequency and timing of the wireless communication device with the packet being received. The sub-band module included in the lower-level PHY portion 262 includes hardware and/or implement algorithms that can be used to detect which subchannel in the allocated frequency band is being used for the packet being received.

Once a packet is detected and the relevant subchannel is established, samples can be forwarded to an upper-level PHY portion 264. The upper-level PHY portion 264 can be included in the PHY processor 216 illustrated in FIG. 2A. In some aspects, upper-level PHY portion 264 is used to process and decode Orthogonal Division Multiplexing (OFDM) symbols (e.g., with the support of a coprocessor module) to reconstruct the full PPDU. The reconstructed PPDU is output by the upper-level PHY portion 264 and subsequently processed by the MAC layer processor 266. The MAC layer processor 266 is used to extract the data payload from the PPDU and provide the relevant information to the HOST layer 268 for consumption.

In some examples, the MAC layer processor 266 illustrated in FIG. 2B can be the same as or similar to the MAC processor 214 illustrated in FIG. 2A. In some cases, the HOST layer 268 illustrated in FIG. 2B can include or otherwise can be the same as or similar to the HOST processor 218 illustrated in FIG. 2A.

FIG. 2C is a schematic block diagram of a transmitter data flow architecture 280 that can be used to transmit RF signals over a wireless medium, in accordance with some examples. More particularly, FIG. 2C illustrates a simplified schematic block diagram of a transmitter data flow architecture 280 used for transmitting radio signals over a WM. Data can be generated from a HOST or APP module 282 and packaged in a MAC level Protocol Data Unit (MPDU) to be routed over the wireless network by the MAC management module 284. The PHY module 286 interfaces with the WM and compiles a PPDU by adding a PHY preamble and the tail to the MPDU. Usually a Modulation Coding Scheme (MCS) for transmission of the packet over the medium is established using a rate control algorithm by the MAC module 284 or the PHY module 286. The modulation scheme selected can define the modulation technique to be used to transmit the data on the WM and the coding rate. Based on the modulation scheme selected, for example Quadrature Amplitude Modulation (QAM) 64, the PPDU is modulated to be transmitted on the WM. The encoder module 288 generates signals corresponding to points of QAM constellation symbols (groups of bits of the PPDU) which can be encoded using polar (r−θ) or cartesian (Q-I) coordinates. The modulation is done by linking the encoder module 288 to a Digital Phase Lock Loop (DPLL) 290. The modulated signals may be filtered by analog filters 292 and transmitted using a transmitting antenna 294.

As noted previously, the systems and techniques described herein can be used to provide low-latency energy detection in a wireless communication network, based on a parallel energy-metering (e.g., energy detection) path that is tapped off in parallel from the receiver down-sampling chain. For example, the parallel low-latency energy detection path can be implemented after a compensation filter of the receiver downsampling chain. In some embodiments, the systems and techniques can be used to perform energy detection for in-band and/or out-of-band (OOB) energy. In some aspects, the energy detection can be performed for in-band and OOB energy simultaneously from the same all-pass filter sections included in an IIR half-band (HB) filter included in the low-latency parallel energy detection path. For example, simultaneous determination of in-band and OOB energy can be performed based on providing both a summer and a subtractor between the all-pass filter sections of the IIR HB filter, as will be described below with reference to the figures.

Energy detection and/or energy detection-based techniques for spectrum sensing can be based on analyzing the energy distribution for one or more measurements obtained by a wireless communication device, to thereby enable various downstream analysis such as the evaluation of signal presence, signal strength, and/or signal quality within specific frequency bands, among various others. The energy detected within a specified frequency band (e.g., the frequency band, frequency range, channel(s), etc., configured for the energy detection) may be in-band energy, referring to energy within the intended communication channel(s), or out-of-band (OOB) energy, typically corresponding to interference and/or noise. The detection of in-band energy and/or OOB energy can facilitate various system functions, including, but not limited to, packet detection, clear channel assessment (CCA), and/or automatic gain control (AGC) configuration, which may be performed by the wireless communication device based on, or according to, the energy detection result(s) previously obtained by the wireless communication device.

There is a need for accurate and efficient energy measurement techniques that can be used to ensure reliable system performance, effective resource allocation, and/or dynamic adaptation to signal and interference conditions by a wireless device in a wireless communication network. As used herein, the terms wireless device and receiver (and/or receiver device) may be used interchangeably. In one illustrative example, a receiver device can be configured to check the in-band energy (e.g., via energy detection techniques) to detect the presence of preambles or headers that indicate the start of a packet. The receiver device may be configured to determine and/or assume a valid transmission is present in response to the detected in-band energy exceeding one or more configured thresholds. In some embodiments, the receiver device may additionally, or alternatively, be configured to monitor out-of-band (OOB) energy to identify and manage co-channel or adjacent-channel interference.

As noted previously, in many examples of energy detection techniques used in various wireless communications systems and standards, the energy detection is often performed at the output of the receiver downsampling chain. In other words, many existing energy detection techniques are implemented in series with the other signal processing operations implemented along the receiver downsampling chain (e.g., existing energy detection techniques may implement energy detection technique as one of a plurality of sequential signal processing steps taken along a single path corresponding to the receiver downsampling chain). While performing energy detection at the output of the receiver downsampling chain can be an effective approach in some scenarios and for some devices, this approach inherently introduces latency to the energy detection process, as energy detection performed at the output of the receiver downsampling chain cannot begin until signal processing for the receiver downsampling chain has completed.

Accordingly, energy detection at the output of the receiver downsampling chain may be seen to have inherent limitations due to the latency introduced by a series of filter delays within the receiver downsampling chain. This latency may additionally exhibit a correspondence to the baseband operating bandwidth, where lower baseband operating bandwidths result in greater delays (e.g., increased latency), which in turn cause slower response times. Increased latency is rarely desirable in wireless communication systems, and in the case of increased latency associated with energy detection by a receiver, this latency may adversely impact time-sensitive functions, including timely clear channel assessment (CCA) reporting to the medium access control (MAC) layer, packet detection related scaling, AGC gain control, and/or gating AGC to trigger on out-of-band interference, etc., among various others.

To address such challenges, embodiments of the present invention incorporate a filter with a reduced latency for energy detection. The embodiments described in this invention present methods and devices utilizing a filter architecture, such as a half-band (HB) filter comprising two or more all-pass filter sections, to enable low-latency energy detection while maintaining high accuracy for energy measurements. Some embodiments of a half-band filter are implemented as a low-pass filter that reduces the maximum bandwidth of sampled data by a factor of two, and have a center frequency equal to fₛ/4, where fₛ is the input sample-rate. An all-pass filter is implemented as a filter that passes all frequencies equally in gain, but changes the phase relationship(s) among various frequencies within the input frequency range provided to the all-pass filter (e.g., an all-pass filter allows all input frequencies through without changes in level, but implemented one or more changes in the phase relationships among particular frequencies within the input frequency range). In some examples, the half-band filter is configured to operate at twice the Nyquist rate, and may efficiently and effectively reject out-of-band energy at higher Nyquist rates. Half-band filters are associated with low computational resource usage and/or overhead, as well as implementation complexity, and is particularly suitable for real-time applications where low latency is desirable. Half-band filters may facilitate rapid signal analysis in energy detection, enabling functions such as early CCA reporting, precise packet detection, and responsive AGC adjustments.

Some approaches to providing energy detection functionality may be implemented using specialized filters to keep desired signals while suppressing interference and noise. However, achieving both high precision and low latency poses a technical challenge due to trade-offs between processing delays and filtering accuracy. Addressing these trade-offs introduces additional costs and complexity to the energy detection functionality, which can be undesirable for resource-constrained or resource-limited wireless devices that are increasingly prevalent for uses cases such as IoT and other low-power communications systems and networks. Accordingly, embodiments of the present invention is used to provide high precision and low latency energy detection with fewer tradeoffs and reduced implementation complexities, based on incorporating a half-band (HB) filter architecture with two or more all-pass filter sections configured to allow detection of in-band and/or OOB energy in parallel with a receiver or transmitter chain corresponding to a receiver or transmitter (respectively) of a wireless communication device.

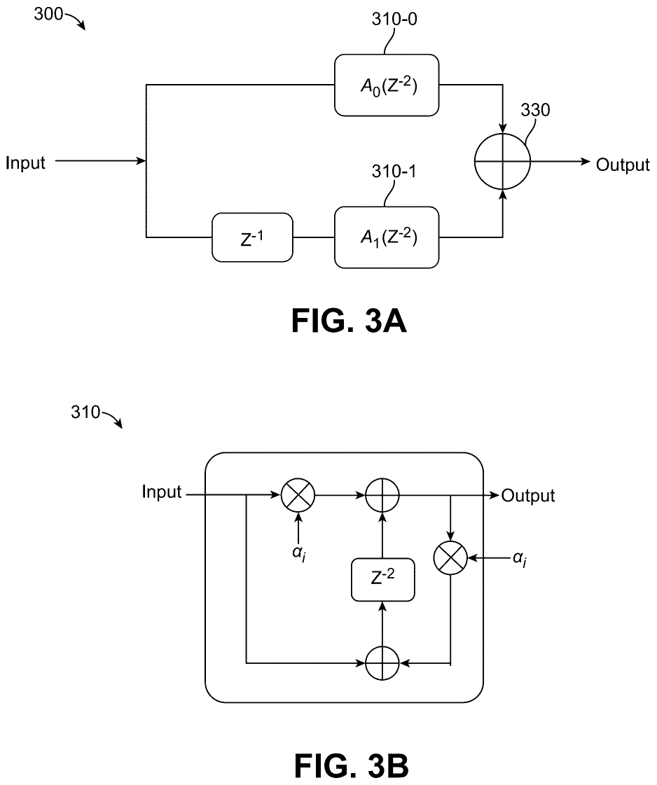

In some embodiments, the half-band filter is an infinite impulse response (IIR) filter, constructed using a combination of multiple all-pass filter sections. For example, FIG. 3A is a diagram illustrating an example of an IIR HB filter 300, where the IIR HB filter 300 includes a first all-pass filter section 310-0 and a second all-pass filter section 310-1. The first all-pass filter section 310-0 may be represented as the all-pass filter A₀(z⁻²) and the second all-pass filter section 310-1 may be represented as the all-pass filter A₁(z⁻²). An input to the IIR HB filter 300 is divided into two parallel branches, with a first parallel branch including the first all-pass filter section 310-0 and a second parallel branch including the second all-pass filter section 310-1. The second parallel branch includes a unit-delay operator z⁻¹ before the second all-pass filter section 310-1 to delay by one sample at the sampling rate of the HB path. The outputs of the first all-pass filter section 310-0 and the second all-pass filter section 310-1 are combined at a combining operation 330 to obtain the output of the IIR HB filter 300. In some embodiments, the combining operation 330 can be implemented as an addition (e.g., summation) of the first and second all-pass filter sections 310-0 and 310-1, and/or can be implemented as a subtraction between the first and second all-pass filter sections 310-0 and 310-1.

FIG. 3B is a diagram illustrating an example structure of an all-pass filter section 310, which may be used to implement one or more of the first all-pass filter section 310-0 and/or the second all-pass filter section 310-1 of the IIR HB filter 300 of FIG. 3A, etc., in accordance with some examples. The example structure for the all-pass filter section 310 as illustrated in FIG. 3B can be used to implement one, or both, of the first all-pass filter section 310-0 and/or the second all-pass filter section 310-1 of FIG. 3A. The all-pass filter sections may be characterized by their magnitude response. In certain embodiments, the magnitude response of the all-pass filters is configured to remain constant (e.g., unity) across all frequencies. For example, the all-pass filter section 310 of FIG. 3B, the first all-pass filter section 310-0 of FIG. 3A, and/or the second all-pass filter section 310-1 of FIG. 3A can be implemented as a filter that passes all frequencies equally in gain, but changes the phase relationship(s) among various frequencies within the input frequency range provided to the all-pass filter (e.g., an all-pass filter allows all input frequencies through without changes in level, but implemented one or more changes in the phase relationships among particular frequencies within the input frequency range). In other embodiments, the magnitude response of the all-pass filter section(s) 310 may be tailored to specific values to meet the unique requirements of a given system design.

In some embodiments of the present disclosure, a half-band filter (e.g., such as the IIR HB filter 300 of FIG. 3A, etc.) is implemented and/or configured with a 3-dB cut-off frequency set at one-quarter of the sampling frequency (fₛ/4). In other aspects, the half-band filter may be implemented as a programmable cut-off frequency filter, allowing customization based on system requirements. This approach enables the efficient implementation of half-band filters with high flexibility in frequency response and design configurations.

In the example of FIG. 3A, the IIR half-band filter 300 is constructed by utilizing the characteristics of the two all-pass filter sections 310-0 and 310-1. For example, the HB transfer of the IIR HB filter 300 can be represented as:

$${H}_{hb} ( {z}^{- 1} ) = {A}_{0} ( {z}^{- 2} ) + {z}^{- 1} {A}_{1} ( {z}^{- 2} ) \qquad Eq . ( 1 )$$

Here, A₀(z⁻²) and A₁(z⁻²) are all-pass filter sections (corresponding to the first all-pass filter section 310-0 and the second all-pass filter section 310-1, respectively) and defined as:

$${A}_{i} ( {z}^{- 2} ) = \frac{{α}_{i} + {z}^{- 2}}{1 + {α}_{i} {z}^{- 2}} , i = 0 , 1 \qquad Eq . ( 2 )$$

For the all-pass filter section(s) according to Eq. (1) and/or Eq. (2), the zeros are positioned at

$$\pm j \frac{1}{\sqrt{{α}_{i}}}$$

and the conjugate poles are positioned at ±\sqrt{αᵢ}. For example, the first all-pass filter section 310-0 corresponds to A₀(z⁻²) and has zeros positioned at

$$\pm j \frac{1}{\sqrt{{α}_{0}}}$$

and conjugate poles positioned at ±\sqrt{α₀}. The second all-pass filter section 310-1 corresponds to A₁(z⁻²) and has zeros positioned at

$$\pm j \frac{1}{\sqrt{{α}_{1}}}$$

and conjugate poles positioned at ±\sqrt{α₁}, etc.

In one configuration, the all-pass filter section(s) 310 can be configured with zeros positioned at specific locations in the complex plane and corresponding conjugate poles. By adjusting design parameters α₀ and α₁, for the first and second all-pass filter sections 310-0 and 310-1, respectively, the performance of the IIR half-band filter 300 may be fine-tuned to achieve desired characteristics, including control over in-band ripple and stop-band attenuation. Such adjustable parameters provide flexibility in tailoring the frequency response of the IIR HB filter 300 and/or the all-pass filter sections 310-0 and/or 310-1 to suit specific system design requirements.

In some embodiments, the two all-pass filter sections 310-0 and 310-1 may be set to have a configured constant magnitude response (e.g. unity) across all frequencies. In such cases, the primary distinction between the two signal paths (e.g., the first signal path corresponding to first all-pass filter section 310-0, and the second signal path corresponding to second all-pass filter section 3101) lies in their phase characteristics.

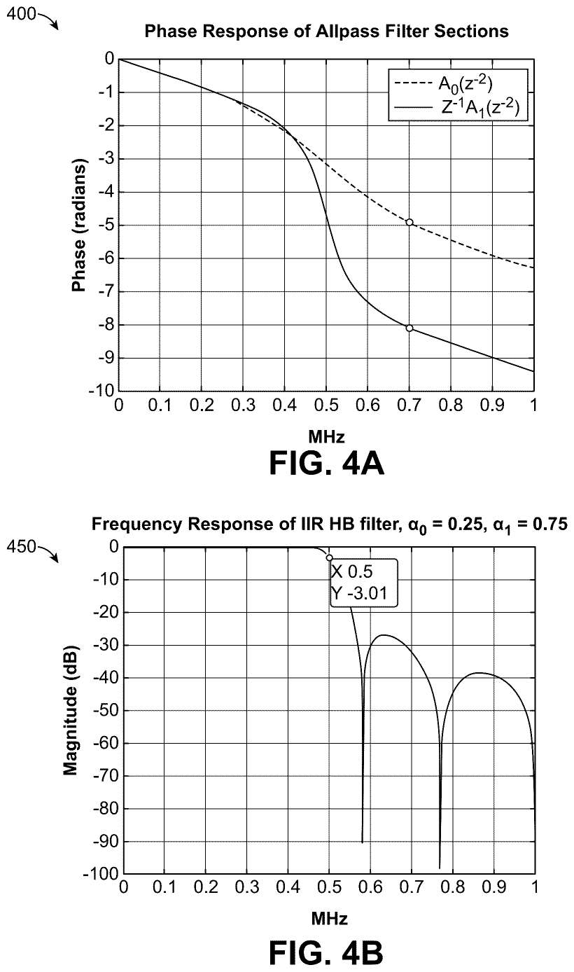

FIG. 4A is a diagram illustrating an example graph 400 of phase responses corresponding to all-pass filter sections (e.g., corresponding to the first all-pass filter section 310-0 and the second all-pass filter section 310-1 of FIG. 3A, etc.), in accordance with some examples. In some aspects, the example graph 400 illustrates the phase responses of the two all-pass filter sections 310-0 and 310-1 for a frequency range from 0 to 1 megahertz (MHz). For instance, as illustrated in FIG. 4A, in a configuration where the parameters α₀=¼ for the first all-pass filter section 310-0, and α₁=¾ for the second all-pass filter section 310-1 (e.g., where A₀ corresponds to α₀, and A₁ corresponds to α₁) and the sampling rate is 2 MHz, the phase responses of the two paths are nearly identical for frequencies below 0.5 MHz, allowing signal components from both paths to combine constructively in this frequency range. In some embodiments, each of the parameters of the all-pass filter sections 310-0 and 310-1 can be a power of two to reduce the implementation complexity.

However, as the frequency increases beyond 0.5 MHz, the phase responses of the two paths begin to diverge. This divergence becomes pronounced at frequencies above approximately 0.6 MHz, where the phase difference between the two paths reaches π radians. At this point, the signal components from the two paths cancel each other out, resulting in a low-pass filter characteristic for the combined output of the two all-pass filter sections 310-0 and 310-1. In some aspects, this design approach may be used to provide a robust and flexible method for implementing half-band filter architectures for energy detection, allowing for precise control over frequency response and filter performance. By leveraging the phase behavior of multiple all-pass filter sections (e.g., 310-0, 310-1, etc.) in the half-band filter (e.g., IIR HB filter 300, etc.), the systems and techniques described herein for energy detection can be seen to support a wide range of applications requiring efficient and adaptable signal processing capabilities. Embodiments of the energy detection method may be configured to filter a wireless signal by a half-band filter such as the IIR HB filter 300, and subsequently detect a power level of the filtered wireless signal generated as the output of the half-band filter (e.g., generated as the output of the IIR HB filter 300, etc.).

In some embodiments, the power level can be determined and/or calculated from the output of the IIR HB filter 300 as a measure of an in-band energy, and/or the power level can be determined from the output of the IIR HB filter 300 as a measure of an out-of-band (OOB) or out-of-channel energy. In an illustrative example, the calculation of the power level corresponding to a measure of in-band energy or a measure of OOB energy can be based on configuring the combination operation 330 of FIG. 3A (e.g., which combines the outputs of the first and second all-pass filters 310-0 and 310-1 to obtain the output of the IIR HB filter 300) as either an addition operation or a subtraction operation, as noted previously. In some aspects, an embodiment of the half-band filter and energy meter is programmable to be configured to detect both in-band and out-of-band energy simultaneously. For example, the IIR HB filter 300 is programmable (e.g., configurable) to implement a low pass filter to measure the in-band energy and/or is programmable (e.g., configurable) to implement a high pass filter to measure the out-of-band energy.

In one embodiment for in-band energy detection by the IIR HB filter 300, the filter's 3-dB cutoff frequency is positioned at fₛ/4, where fₛ represents the sampling rate. FIG. 4B is a diagram illustrating an example graph 450 of the magnitude response of an IIR HB filter (e.g., the IIR HB filter 300, etc.) with a sampling rate of 2 MHz, in accordance with some examples. As illustrated in the example graph 450 of FIG. 4B, in the magnitude response of the IIR HB filter 300 and at the sampling rate of 2 MHz, the filter's 3-dB cutoff frequency corresponds to 0.5 MHz. Frequencies below this cutoff are passed with minimal attenuation by the IIR HB filter, while frequencies above the cutoff experience progressively greater attenuation beyond the 3-dB cutoff frequency of 0.5 MHz. In some aspects, the 3-dB cutoff frequency signifies the point at which the signal's power is reduced to half of its original value, thereby representing and/or defining the transition of the IIR HB filter (e.g., IIR HB filter 300, etc.) from passband to stopband. In some implementations, half-band filters may be configured to adjust the cutoff frequency. For example, a programmable half-band filter can be a half-band filter implemented with an adjustable cutoff frequency according to one or more inputs, configurations, programming, etc., indicative of the desired value of the adjustable cutoff frequency for the programmable half-band filter, etc.

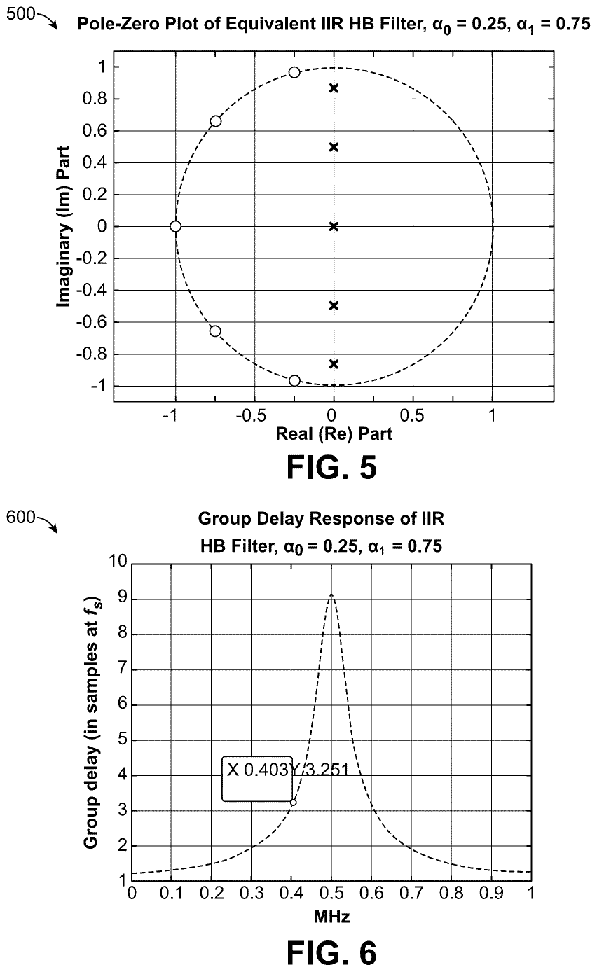

FIG. 5 is a diagram illustrating an example graph of a pole-zero configuration 500 of an IIR HB filter, such as the IIR HB filter 300 of FIG. 3A, etc. in accordance with some embodiments. The pole-zero configuration 500 of the IIR half-band filter, as illustrated in the pole-zero plot of FIG. 5, reveals further insights into its frequency-selective behavior. In this example, the IIR HB filter's zeros are all positioned in the left half-plane (e.g., the negative-valued portion of the horizontal real-valued (Re) axis). This configuration effectively suppresses frequencies above the HB filter cutoff frequency of fₛ/4, thereby allowing the HB filter to pass lower frequencies while attenuating higher ones. By strategically placing poles and zeros, the half-band filter (e.g., IIR HB filter 300, etc.) achieves a selective frequency response suitable for applications requiring efficient separation of low-frequency components from higher-frequency signals.

An additional advantage of employing a half-band filter for energy detection lies in the favorable group delay response that may be achieved by the use of the half-band filter, such as the IIR HB filter 300, etc. For example, the group delay response for the IIR half-band filter 300 is depicted in FIG. 6, which illustrates an example graph 600 of the group delay response for an IIR HB filter with α₀=0.25 (e.g., corresponding to the first all-pass filter section 310-0) and with α₁=0.75 (e.g., corresponding to the second all-pass filter section 310-1). As seen in the example graph 600 of the group delay response for the IIR HB filter, the group delay for the IIR HB filter 300 is, on average, less than three samples at the input sampling rate (e.g., fₛ). This represents a significantly low delay, making the IIR HB filter 300 suitable for scenarios where rapid processing and/or low latency is required or otherwise beneficial. In comparison, the corresponding group delay for a finite impulse response (FIR) filter (e.g., an FIR5 filter, etc.) as may be used in the receiver downsampling chain may be equal to a delay of 19 samples at the same sampling rate fₛ, which is considerably larger (e.g., a considerably longer delay). This difference in the number of samples in the group delay for the IIR HB filter 300 and the group delay for an example FIR5 filter in the receiver downsampling chain highlights the efficiency of using a half-band filter such as the IIR HB filter 300 in reducing latency for energy measurements. For example, the reduced group delay associated with the IIR HB filter 300 is used to ensure that the system can detect energy and respond to signal changes more quickly (e.g., with less/lower latency, etc.), thereby enhancing the performance of the system (e.g., wireless communication device, receiver, etc.) in dynamic environments. Additionally, the lower delay profile of the half-band filter (e.g., IIR HB filter 300, etc.) contributes to improved timing synchronization and reduced processing overhead in downstream components, further demonstrating the advantages of using the IIR HB filter 300 in latency-sensitive applications such as energy detection and/or spectrum sensing, among others.

In some embodiments, to enhance the attenuation characteristics of the system, multiple half-band filters may be cascaded for power level detection. For example, by employing a cascade of two half-band filters, it is possible to further achieve more (e.g., greater) attenuation for unwanted frequencies. This approach may be particularly effective in applications which demand sharper frequency cutoffs or greater suppression of undesired frequency components. Cascading multiple half-band filters may correspond to an increase in the overall group delay of the system (e.g., as additional filters are introduced to the cascade, the cumulative delay introduced by each stage increases, leading to a larger total group delay). For instance, the magnitude response of the two cascaded IIR half-band filters demonstrates that the signal attenuation is twice the attenuation magnitude of a single IIR half-band filter. However, the group delay response of the two IIR half-band cascaded filters is approximately twice the group delay of a single IIR half-band filter.

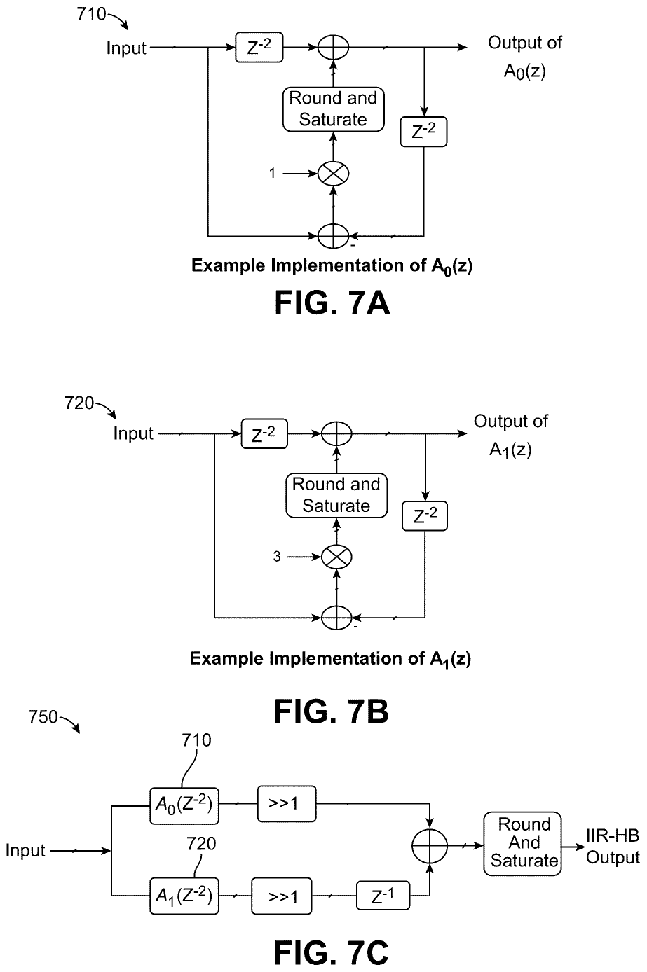

In some embodiments, aspects of the invention include one or more fixed-point implementations of the half-band filter using the all-pass filter sections (e.g., one or more fixed-point implementations of the IIR HB filter 300 using the first and second all-pass filter sections 310-0 and 310-1 of FIG. 3A, etc.). For example, FIGS. 7A-7C are diagrams illustrating example fixed-point implementations corresponding to an IIR HB filter using all-pass filter sections, in accordance with some embodiments. In particular, FIG. 7A illustrates an example fixed-point implementation 710 for a first all-pass filter section A₀(z) that can correspond to the first all-pass filter section 310-0 of FIG. 3A, and FIG. 7B illustrates an example fixed-point implementation 720 for a second all-pass filter section A₁(z) that can correspond to the second all-pass filter section 310-1 of FIG. 3A. FIG. 7C illustrates an example fixed-point implementation 750 for a half-band filter (e.g., IIR HB filter, etc.) corresponding to the IIR HB filter 300 of FIG. 3A, where the fixed-point implementation 750 of the HB filter includes and/or is based on the fixed-point implementation 710 of the first all-pass filter section of FIG. 7A and the fixed-point implementation 720 of the second all-pass filter section of FIG. 7B.

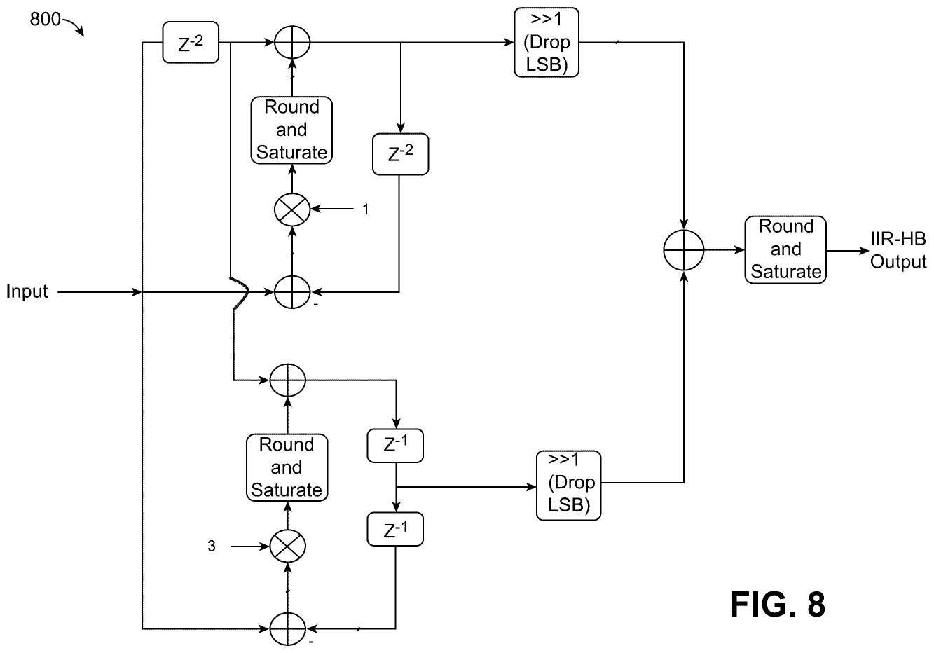

In some embodiments, the example fixed-point implementations 710, 720, and 750 of FIGS. 7A, 7B, and 7C (respectively) may be simplified by noting that the input and its delayed version are same across A₀(z⁻²) (e.g., the first all-pass filter fixed-point implementation 710) and A₁(z⁻²) (e.g., the second all-pass filter fixed-point implementation 720), and hence one delay register may be reduced for the fixed-point implementation of the HB filter 750, as shown in the example of FIG. 8, which illustrates a reduced fixed-point implementation 800 for the HB filter of FIG. 7C. In one embodiment, inputs of the two all-pass filter sections (e.g., the upper and lower branch portions) included in the reduced fixed-point implementation 800 of the half-band filter for energy detection can be implemented and/or configured to share only one delay register, as illustrated in the example of FIG. 8.

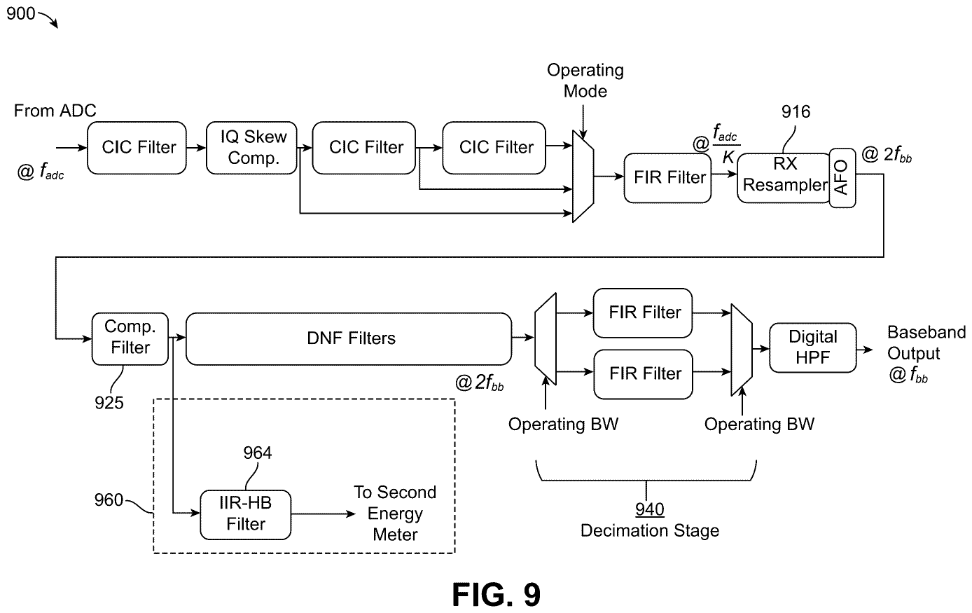

FIG. 9 is a diagram illustrating an example of a receiver downsampling chain 900 configured to receive a signal from an analog-to-digital (ADC) converter and output a processed signal to a baseband module, where the receiver downsampling chain 900 includes a parallel branch 960 with an IIR-HB filter 964 that can be used for energy detection, in accordance with some examples. In some embodiments, the parallel branch 960 including the IIR-HB filter 964 can be tapped off the receiver downsampling chain 900 at the output of a compensation filter 925 included in the receiver downsampling chain 900 (e.g., the parallel branch 960 for low-latency energy detection starts from a point after/on the output of the compensation filter 925). In an illustrative example, the IIR-HB filter 964 of FIG. 9 can be the same as or similar to, or may otherwise correspond to, one or more of the IIR HB filter 300 of FIG. 3A, the fixed-point HB filter implementations of FIG. 7C and/or FIG. 8, and/or any other HB filter(s) herein.

As illustrated in the example of FIG. 9, the receiver downsampling chain 900 receives an input signal from an analog-to-digital converter (ADC). For example, the receiver downsampling chain 900 receives an input signal comprising the output of an ADC, at a frequency f_{adc} (e.g., the output frequency from the ADC). The receiver downsampling chain 900 generates and outputs a processed baseband output signal to a baseband module (not shown) at an output frequency of f_{bb} (e.g., baseband frequency). The receiver downsampling chain 900 can be included within and/or implemented by a receiver device and/or a receiver of a wireless communication device, etc. The input signal from the ADC can be received from an ADC included in the same receiver device or receiver, and the baseband module receiving the output of the receiver downsampling chain 900 can likewise be included within and/or implemented by the same receiver device or receiver.

In one illustrative example, the receiver downsampling chain 900 shapes the noise (especially the quantization noise) at high frequencies. In existing approaches to energy detection, an energy meter for energy detection is typically positioned at the end of the receiver downsampling chain 900, so that the quantization noise can be removed by the receiver downsampling chain 900 components upstream of the series energy detection component or module. For example, in some existing digital receiver implementations with energy detection at the end of the receiver downsampling chain, the ADC output is resampled and passed through compensation and decimation filters of the receiver downsampling chain 900 to shape quantization noise and set the final baseband rate before demodulation.

Such implementations will typically position the energy meter (e.g., energy detection component) at the end of the receiver downsampling chain so that quantization noise has been suppressed by that chain, which may improve energy detection stability but introduces aggregate group delay from the cascaded filters and decimators that must complete signal processing in the receiver downsampling chain 900 prior to initiating the energy detection. This accumulated group delay associated with the existing approaches to energy detection at the end of the receiver downsampling chain can constrain time-critical or time-bound behaviors of the receiver device. For example, as noted previously, the downsampling receiver chain latency grows as operating bandwidth narrows, and such latency may adversely impact time-sensitive functions including timely CCA indications to MAC, packet-detector scaling, and/or AGC gating. From a MAC/PHY interface perspective, delays or increased latency associated with the energy detection may be seen to increase contention overhead and/or bias backoff behavior.

In an illustrative example, for the receiver downsampling chain 900 shown in FIG. 9, the signal is resampled by a resampler 916 (e.g., a resampling component or module, etc.) from an ADC rate to baseband rate, for example, from 57 MHz to 2 MHz for a 1 MHz mode. The output of the resampler 916 (e.g., resampling component or module) is then fed to a compensation filter 925 (e.g., a Comp4 filter, etc.), where the quantization noise is cleaned up at the output of the compensation filter 925.

In some embodiments, the systems and techniques can be configured to use an energy meter that is associated with the parallel branch 960 to perform the low-latency energy detection. For example, the energy meter corresponds to the “To second energy meter” path shown at the output of IIR-HB filter 964 on the second, parallel branch 960 after the compensation filter 925 of the receiver downsampling chain 900. In some examples, the energy meter is positioned at the output of the IIR-HB filter 964, which, as a half-band filter, can serve as an optimal choice for achieving low-latency energy filtering. As noted previously, the IIR-HB filter 964 is positioned at the output of the compensation filter 925 included in the existing receive downsampling chain 900. In this embodiment, the compensation filter 925 is running at two times the baseband rate (e.g., 2 f_{bb}).

Additionally, the half-band filter (e.g., IIR-HB filter 964) may operate in parallel with a decimation stage 940 (e.g., FIR5) in the signal processing path of the receiver downsampling chain 900. For example, the receiver downsampling chain 900 includes the decimation stage 940 after the compensation filter 925, such that the decimation stage 940 (e.g., including one or more FIR filters) operates in parallel with the low-latency energy detection using the parallel branch 960 after the compensation filter 925 and included in the IIR-HB filter 964 before the second energy meter. In an illustrative example, the systems and techniques herein use this configuration of decoupling the energy detection path (e.g., corresponding to the parallel path/branch 960 with the IIR-HB filter 964) and the demodulation path (e.g., associated with the receiver downsampling chain 900 including the compensation filter 925 and the decimation stage 940) enables low latency in energy detection.

Some embodiments may use an energy meter to perform the energy detection based on the output of the IIR-HB filter 964 on the second, parallel branch/path 960 after the compensation filter 925. For example, aspects of the present disclosure include one or more energy meters coupled to the output of the IIR-HB filter 964, where the energy meter may be implemented in various designs and configurations that utilize the absolute value of the output from the half-band filter e.g., IIR-HB filter 964). In some embodiments, the output of the IIR-HB filter 964 on the parallel path 960 may be processed through an averaging filter, such as an exponential averaging filter, which may be implemented as a single-pole IIR filter. The rise time and delay characteristics of such filter may be adjusted based on a configurable pole parameter.

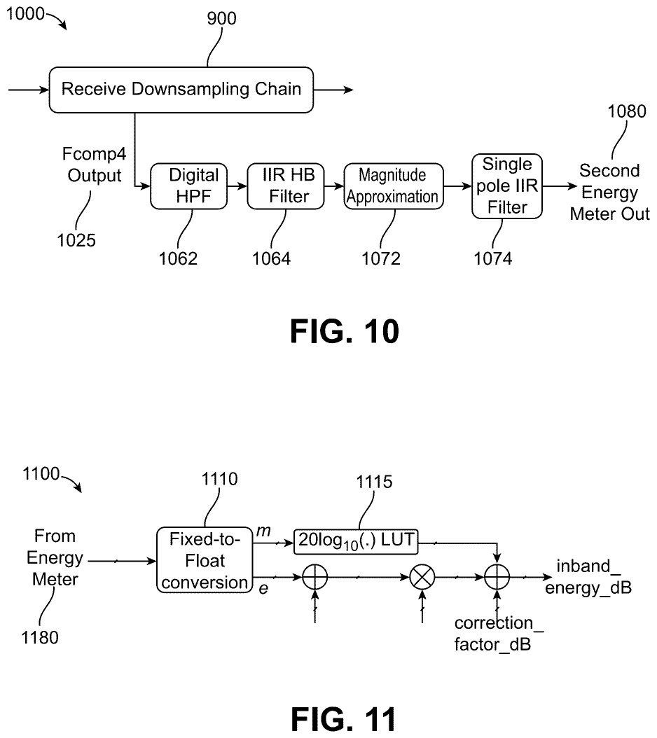

FIG. 10 is a block diagram illustrating an example of an energy meter 1000 configured to generate an in-band energy measurement, in accordance with some embodiments. In some aspects, the energy meter 1000 can be used to perform the energy detection based on the parallel branch from the receive downsampling chain 900. For example, the energy meter 1000 is implemented based on a parallel branch tapped from the output of the compensation filter 925 of FIG. 9, corresponding to the Fcomp4 Output 1025 shown in FIG. 10. In some aspects, the energy meter 1000 is configured to generate an in-band energy measurement based on the output of the IIR-HB filter 964 of FIG. 9, using the compensation filter 925 output signal Fcomp4 Output 1025, etc.

In some aspects, the energy meter 1000 includes a digital high-pass filter (HPF) 1062, an IIR half-band filter 1064 (e.g., which can be the same as or similar to the IIR HB filter 964 of FIG. 9, etc.), a magnitude approximation component 1072, and a single pole IIR filter 1074. These interconnections may vary depending on the specific implementation of the energy measurement system, enabling flexibility in design to suit various operational requirements. For energy measurements, the energy meter 1000 can be configured to ensure that any DC signal component(s) is removed to prevent bias in the measurement corresponding to the energy meter output 1080 (e.g., also referred to as the energy detection output 1080, etc.). In some embodiments, the energy meter 1000 ensures DC signal component removal based on the half-band filter (e.g., IIR HB filter 1064) operating on a DC-cancelled input signal. The DC-cancelled input signal is generated as the output of the digital HPF 1062, for example based on a wireless signal (e.g., the output 1025 of the compensation filter 925 of the receiver downsampling chain 900) passing first through the digital HPF 1062 before filtering by the IIR half-band filter 1064 with a predetermined cut-off frequency is performed. In some embodiments, the magnitude approximation component 1072 is configured to receive the filtered wireless signal from the IIR HB filter 1064 output. The magnitude approximation component 1072 generates (e.g., outputs) magnitude values to the single pole IIR filter 1074. The single pole IIR filter 1074 generates a power level of the wireless signal as the energy meter (e.g., energy detection) output 1080.

In some embodiments, the energy detection output 1080 represents the power level in decibel (dB) values, which for example may provide a practical indication of the relative signal strength determined by the energy meter 1000 and/or energy detection process described herein. Such representations may also facilitate referencing the input signal level in decibel-milliwatts (dBm). For instance, an exemplary implementation is illustrated in FIG. 11, which is a diagram illustrating an example of an implementation 1100 configured to determine in-band energy information (e.g., power level) on a decibel (dB) scale, in accordance with some embodiments.

As shown in the example of FIG. 11, an input signal 1180 can be received from the energy meter (e.g., energy meter 1000 of FIG. 10), and may be the same as or similar to the energy meter output signal 1080 of FIG. 10. Based on the input signal 1180 from the energy meter, the implementation 1100 of FIG. 11 can be used to compute (e.g., determine) the energy detection power level on a dB scale, providing flexibility for use with different filter designs and signal processing systems. In some embodiments, a fixed-to-float conversion 1110 is used, along with a lookup table (LUT) 1115, to provide and/or perform conversion of the output signal 1080 of the energy meter 1000 (e.g., the input signal 1180 of FIG. 11) to energy values represented in dB scale. In one illustrative example, the LUT 1115 is provided downstream from the fixed-to-float conversion 1110, and may be implemented in some embodiments as a 20 log₁₀(⋅) LUT, as shown in the example of FIG. 11.

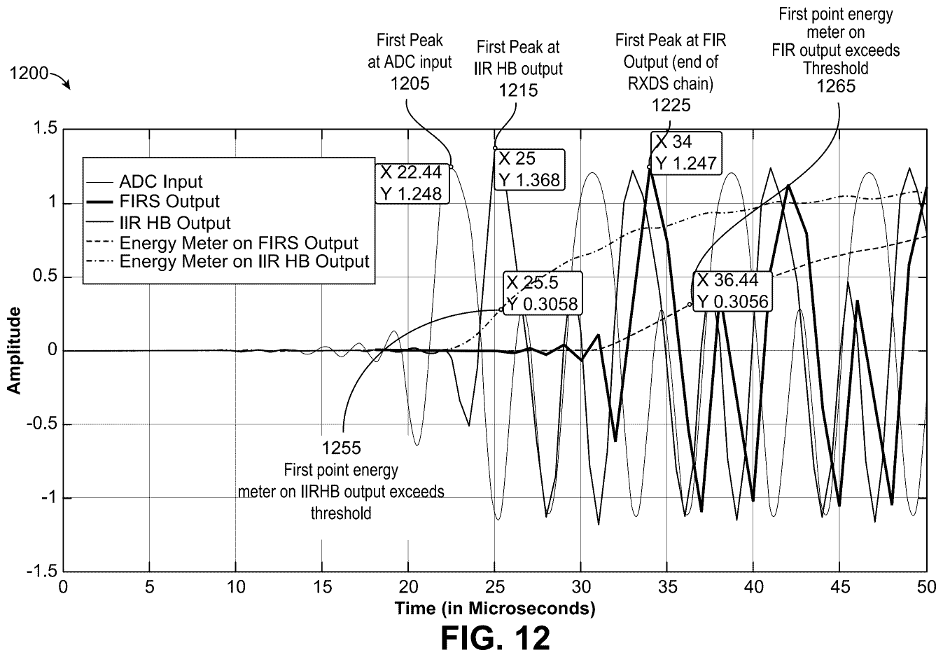

In some examples, temporal analysis of signal processing within a receiver downsampling chain (e.g., such as receiver downsampling chain 900, etc.) may be used for evaluating system performance, particularly in latency-sensitive applications. For instance, FIG. 12 is a diagram illustrating an example graph 1200 of respective latencies observed at various stages within the receiver downsampling chain, in accordance with some embodiments. These latency measurements highlight the progression of signals within the system with time. Notably, the first signal peak at the output of the half-band filter (e.g., IIR half-band or equivalent) occurs at point 1215, which is located within approximately 2.5 microseconds from the initial peak at the analog-to-digital converter (ADC) input at point 1205. In contrast, the first signal peak at the output of the final decimation stage 940 (e.g., FIR5) occurs at point 1225, which is observed approximately 12 microseconds after the initial peak at the ADC input at point 1205.

Furthermore, an energy meter operating at the output of the half-band filter 964 of FIG. 9 demonstrates rapid responsiveness. Specifically, the energy meter (e.g., energy meter 1000 of FIG. 10, etc.) requires less than one microsecond to measure a level that exceeds a predefined (e.g., configured) threshold, thereby signaling the presence of energy (e.g., a positive energy detection result indicative of an occupied channel, etc.). This fast response time enables early detection of energy in the signal chain, with lower latency, making such configurations advantageous for low-latency applications. The described latency performance metrics and energy detection capabilities may vary based on system design, filter types, and parameter configurations, providing flexibility for implementation in diverse signal processing architectures.

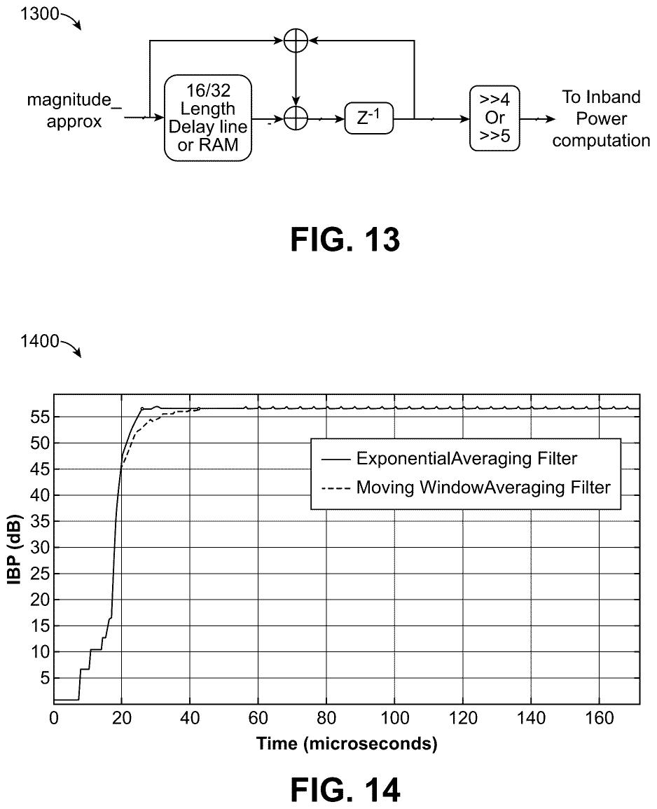

In some embodiments of the energy detection method for communication systems, an averaging filter is used for the computation of the power level following the magnitude approximation 1072 of FIG. 10. For example, the averaging filter can be implemented as a moving window averaging filter, such as the example moving window averaging filter 1300 of FIG. 13. The input to the example moving window averaging filter 1300 is the output of the magnitude approximation 1072, and the output of the example moving window averaging filter 1300 can be provided to an in-band power computation by the energy meter 1000 and/or in-band power computation corresponding to the low-latency energy detection described herein.

In some embodiments, an exponential averaging filter (e.g. implemented as a single-pole IIR filter, such as the single-pole IIR filter 1074 of FIG. 10, etc.), is utilized for the same purpose as the example of the moving window averaging filter described above and shown in the example of FIG. 13. The choice of averaging filter can impact the system's response characteristics, with each offering distinct advantages depending on the application requirements. In some aspects, though the half-band filter provides a low-latency path for the signal, the computation of the power level for energy detection by the energy meter 1000 may be influenced by the choice of the averaging filter applied post magnitude approximation 1072. Exponential averaging filters generally have a slower rise time compared to moving window averaging filters when both are configured for the same averaging time. This slower rise time may affect the responsiveness of the power computation. For example, FIG. 14 is a diagram illustrating an example graph 1400 of rise times corresponding to a moving averaging filter and an exponential averaging filter, in accordance with some examples, and presents a comparison between the rise times for moving window averaging filter and exponential averaging filter.

In one embodiment, both averaging techniques are made available for the systems and techniques described herein, with a moving window averaging filter added alongside an exponential averaging filter. The system may allow for the selection of either filter depending on the desired performance characteristics. The moving window averaging filter (e.g., such as the moving window averaging filter 1300 of FIG. 13, among various others) typically provides a faster response, making it suitable for dynamic signal environments requiring quick adaptation. Conversely, the exponential averaging filter offers a smoother, more gradual response, which may be preferred in scenarios where a steadier output is critical. By offering the flexibility to choose between such multiple approaches, the system can adapt to diverse requirements, ensuring optimal performance across a range of operational conditions.

In some embodiments, the output of a moving window averaging filter (e.g., such as the moving window averaging filter 1300 of FIG. 13, etc.) can be represented as y[n], which is given as:

$$y [ n ] = \frac{1}{N} {\sum }_{k = n}^{n - N + 1} x [ n ] \qquad Eq . ( 3 )$$

Eq. (3) can be re-written in a recursive relation as:

$$y [ n ] = \frac{x [ n ] - x [ n - N ]}{N} + y [ n - 1 ] \qquad Eq . ( 4 )$$

In certain embodiments of register transfer level (RTL) implementations, the required delay line for random access memory (RAM) may be optimized by selecting specific values for operational parameters. For example, the parameter N in Eq. (3) and/or Eq. (4) may be configured to have a value of 4 or 5, facilitating efficient utilization of memory resources while ensuring compliance with the system's timing and performance requirements. By restricting the delay line to such values, it may be possible to achieve an optimal balance between minimizing hardware complexity and ensuring adequate signal processing capability. The specific value selection may also depend on the desired trade-offs between resource utilization and latency in the overall design.

In some embodiments, it may often be necessary and/or desirable to convert the computed power level in decibels (dB) to an input-referred power level in decibel-milliwatts (dBm). Such conversions may be beneficial for various system functions, including but not limited to gating receiver blocks, range selection for packet detection, and reporting the received signal strength indicator (RSSI) to higher layers, such as the media access control (MAC) layer.

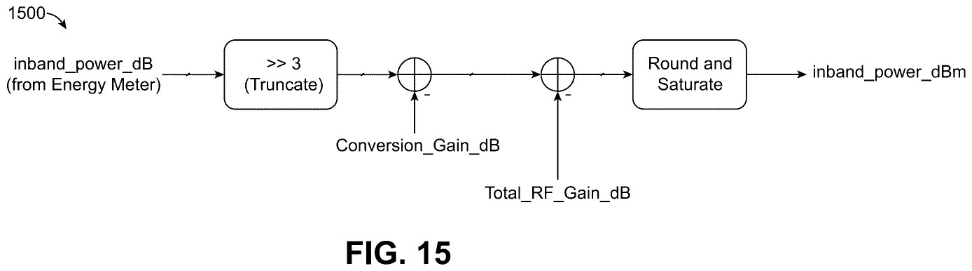

A simplified block diagram for converting the power level from dB to an input-referred level in dBm is illustrated in FIG. 15. In particular, FIG. 15 is a diagram illustrating an example of power level conversion 1500 from a dB representation to an input-referred level in dBm, in accordance with some embodiments.

This power conversion process implemented by the power level conversion 1500 can be configured to leverage a conversion gain parameter (e.g., “Conversion_Gain_dB” shown in FIG. 15), which acts as a scaling factor for the conversion from voltage to power. The conversion gain parameter accounts for the overall system impedance, which is not restricted to the standard 50 Ohms, as well as any additional system losses. Since these factors can vary depending on the design, the conversion gain parameter can be calibrated during bench testing to ensure accuracy. To compute the input-referred signal level at the antenna input, the total RF gain (expressed in dB) is subtracted from the measured power gain in dBm.

In some aspects, an embodiment of the half-band filter for low latency energy detection at the receiver may be provided as a programmable cut-off IIR filter, where the predetermined cut-off frequency of the programmable cut-off IIR half-band filter is adjustable to adapt to multiple standards. For example, the programmable cut-off IIR filter can be configured with different values for the pre-determined (e.g., programmed and/or configured) cut-off frequency in order to cater to different bandwidths without the need for different receiver downsampling chains 900. For instance, regulatory authorities in different regions, countries, etc., may impose specific guidelines that differ from those in other regions, countries, etc. While some communication standards, such as IEEE 802.11ah, specify spectral mask requirements, they do not fully encompass all region-specific regulatory requirements. For example, additional requirements at band edges or within specific portions of the spectrum may exist, such as those defined by the Federal Communications Commission (FCC) in the 902-928 MHz ISM band. Meeting such diverse requirements may present significant challenges, particularly as the number of supported regulatory domains increases. In some cases, existing transmitter designs may comply with standard spectral masks but fail to meet stricter regulatory requirements in specific regions. Redesigning transmitter filters to accommodate such variations can be resource-intensive and impractical, particularly for systems intended for global deployment. In some embodiments of the present invention, this programmable cut-off IIR filter can be used in a transmitter upsampling chain of a wireless communication device to dynamically configure the cut-off characteristics to align with the spectral requirement of a specific regulatory domain.

For example, in some embodiments, a transmitter upsampling chain can be configured to use a programmable cut-off IIR filter to dynamically configure cut-off characteristics according to a configuration and/or spectral requirement. For instance, the programmable cut-off IIR filter can be selectively enabled or disabled based on the operational requirement, where the selective enabling or disabling is performed according to an enable/bypass signal input to the programmable low-pass IIR filter. Embodiments of the programmable cut-off IIR filter 1664 provide a flexible and low-complexity solution for ensuring compliance with diverse regulatory requirements without necessitating significant changes to existing receiver or transmitter designs. The ability to dynamically adjust the filter characteristics enables efficient adaptation to varying spectral guidelines, thereby simplifying system development and deployment in multiple regulatory regions. Embodiments of the wireless communication device incorporate a programmable cut-off IIR filter to minimize the impact on existing system architecture while providing the flexibility needed to address evolving regulatory standards.

In some embodiments, a programmable cut-off IIR filter is implemented based on the previously disclosed low latency IIR half-band filter described with respect to various ones of FIGS. 3A-15. In some embodiments, the IIR half-band filter is constructed using two all-pass filter sections, as described in Eq. (1). In some examples, a programmable cut-off IIR filter can be configured to act as a low-pass filter (LPF) and/or can be configured to act as a high-pass filter (HPF) according to configuring a combining operation between the two all-pass filter section paths to perform addition or subtraction of the respective outputs from the two all-pass filter sections. For example, the programmable cut-off IIR filter is configured to provide a programmable LPF or HPF based on configuring the addition or subtraction path for the combining operation provided between the two all-pass filter sections of the programmable cut-off IIR filter, in a manner the same as or similar to that described previously above with respect to the configuration of the HB IIR filter of FIGS. 3A-15 to act as a low-pass or high-pass filter based on using an addition or subtraction operation at the combination of the two all-pass filter section paths. In some aspects, the programmable cut-off IIR filter is implemented as a programmable LPF with an addition combination path between the two all-pass filter sections, wherein the programmable LPF configuration is used for in-band energy measurement(s) by the programmable LPF configuration of the programmable cut-off IIR filter. In another example, the programmable-cut-off IIR filter is implemented as a programmable HPF with a subtraction combination path between the two all-pass filter sections, wherein the programmable HPF configuration is used to perform out-of-band (OOB) energy measurement(s) by the programmable HPF configuration of the programmable cut-off IIR filter. An embodiment of achieving a variable cut-off frequency in a low-pass filter involves altering the fixed cut-off frequency of a filter to a desired frequency. This cut-off frequency alternation enables the adaptation of filters to varying operational or regulatory requirements without necessitating a complete redesign. In this embodiment, a spectral transformation is applied to the original transfer function of the half-band filter to adjust its cut-off frequency. One example of such a transformation is a low-pass to low-pass transformation, which replaces the delay element in the original filter's transfer function with another all-pass function as shown in Eq. (5), below:

$${z}^{- 1} \to \frac{{z}^{- 1} - β}{1 - β {z}^{- 1}} \qquad Eq . ( 5 )$$

This all-pass function of Eq. (5) includes the parameter β, which may be used to define the desired (e.g., programmable, configured, etc.) cut-off frequency, thereby providing a mechanism for dynamically tuning the filter's frequency response (e.g., the frequency response of an example programmable low-pass IIR filter, etc.). In some embodiments, the parameter β can be represented and/or determined according to:

$$β = \frac{sin ( \frac{{ω}_{0} - {ω}_{d}}{2 {f}_{s}} )}{sin ( \frac{{ω}_{0} + {ω}_{d}}{2 {f}_{s}} )} \qquad Eq . ( 6 )$$

Here, ω₀ represents the cut-off frequency of the original prototype low-pass transfer function, and ω_{d} represents the desired cut-off frequency configured or programmed for the programmable low-pass IIR filter. Applying the above transformation of Eqs. (5) and/or (6) to the original IIR half-band transfer function, the transformed filter function is obtained as:

$${H}_{new} ( {z}^{- 1} ) = {A}_{0} ( {z}^{- 2} ) + {A}_{1} ( {z}^{- 2} ) {\vert}_{{z}^{- 1} \to \frac{{z}^{- 1} - β}{1 - β {z}^{- 1}}} = \frac{{{α}_{0} ( \frac{{z}^{- 1} - β}{1 - β {z}^{- 1}} )}^{2}}{1 + {{α}_{0} ( \frac{{z}^{- 1} - β}{1 - β {z}^{- 1}} )}^{2}} + ( \frac{{z}^{- 1} - β}{1 - β {z}^{- 1}} ) \cdot \frac{{{α}_{1} ( \frac{{z}^{- 1} - β}{1 - β {z}^{- 1}} )}^{2}}{1 + {{α}_{1} ( \frac{{z}^{- 1} - β}{1 - β {z}^{- 1}} )}^{2}} \qquad Eq . ( 7 )$$

In some embodiments, the low-pass to low-pass spectral transformation is achieved by replacing the delay element in the prototype filter's transfer function with an all-pass section as shown in Eq. (5). The resultant transformed filter transfer function of Eq. (7), requires the implementation of nine first-order all-pass sections, leading to increased implementation complexity.

In order to reduce the complexity of the resultant transformed filter transfer function of Eq. (7), some embodiments of the invention present a novel approximation method for the transformation function of Eq. (7) as:

$${z}^{- 2} \to {( \frac{{z}^{- 1} - β}{1 - β {z}^{- 1}} )}^{2} to {z}^{- 2} \to {z}^{- 1} ( \frac{{z}^{- 1} - {β}_{0}}{1 - {β}_{0} {z}^{- 1}} ) , \vert {β}_{0} \vert < 1 \qquad Eq . ( 8 )$$

Note that the parameter β₀, introduced in the approximation of the transfer function provided by Eq. (8) above, may in general be different from the value of the original parameter β introduced and used in Eqs. (5)-(7). Using this approximation shown in Eq. (8), only four all-pass sections need to be implemented. The approximation leads to the modified transfer function as shown below in Eq. (9):

$${H}_{new} ( {z}^{- 1} ) = \frac{{α}_{0} + {z}^{- 1} ( \frac{{z}^{- 1} - {β}_{0}}{1 - {β}_{0} {z}^{- 1}} )}{1 + {α}_{0} {z}^{- 1} ( \frac{{z}^{- 1} - {β}_{0}}{1 - {β}_{0} {z}^{- 1}} )} + {z}^{- 1} \frac{{α}_{1} + {z}^{- 1} ( \frac{{z}^{- 1} - {β}_{1}}{1 - {β}_{1} {z}^{- 1}} )}{1 + {α}_{1} {z}^{- 1} ( \frac{{z}^{- 1} - {β}_{1}}{1 - {β}_{1} {z}^{- 1}} )} = {G}_{0} ( {z}^{- 1} ) + {z}^{- 1} {G}_{1} ( {z}^{- 1} ) \qquad Eq . ( 9 )$$

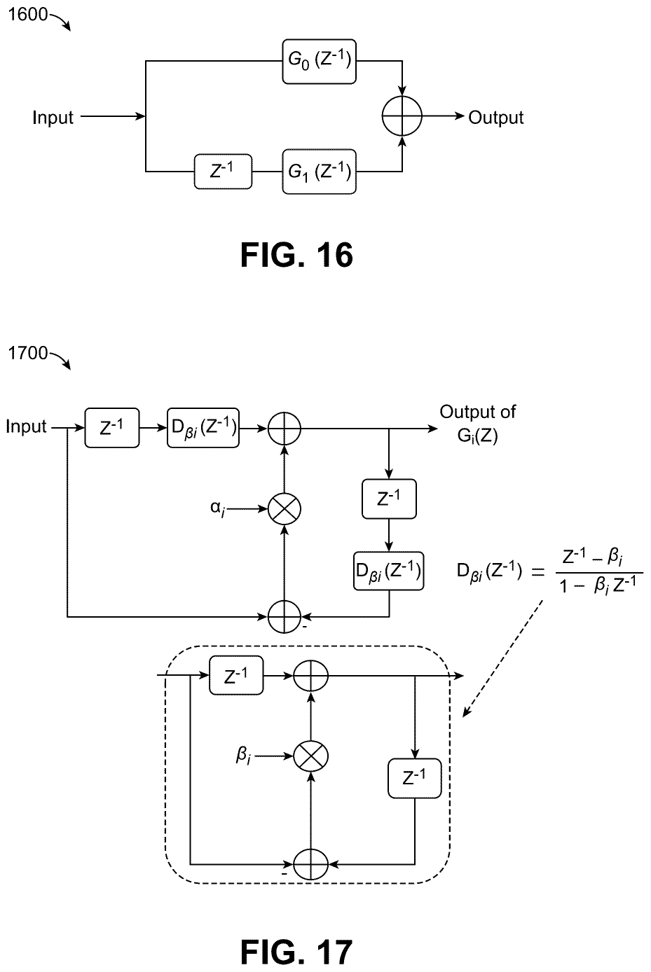

By varying the values of β₀ and β₁, filters with a different range of cut-off frequencies can be obtained and used for the low-latency energy detection described herein. For example, FIG. 16 is a diagram illustrating an example filter implementation 1600 with a modified transfer function according to Eq. (9), in accordance with some examples. FIG. 17 is a block diagram illustrating an example implementation 1700 of the filter Gᵢ(z⁻¹), i=0,1, which for example can be used to implement the first HB filter G₀(z⁻¹) of FIG. 16 and the second HB filter G₁(z⁻¹), etc.

In the example of FIG. 17, the group delay element is represented as the group delay element D_{β}_{ᵢ}(z⁻¹). In some embodiments, the group delay can be calculated as:

$${D}_{{β}_{i}} ( {z}^{- 1} ) = \frac{{z}^{- 1} - {β}_{i}}{1 - {β}_{i} {z}^{- 1}} \qquad Eq . ( 10 )$$

In some implementations, the parameters used in transformation and approximation may be quantized to accommodate fixed-point arithmetic. For example, the quantization of the parameters for transformation and approximation is performed to ensure compatibility with hardware implementations while maintaining sufficient precision to achieve the desired performance. Quantization of such parameters may be used to enable efficient deployment of the filter designs, such as in resource-constrained environments where computational and memory resources are limited, among various others.

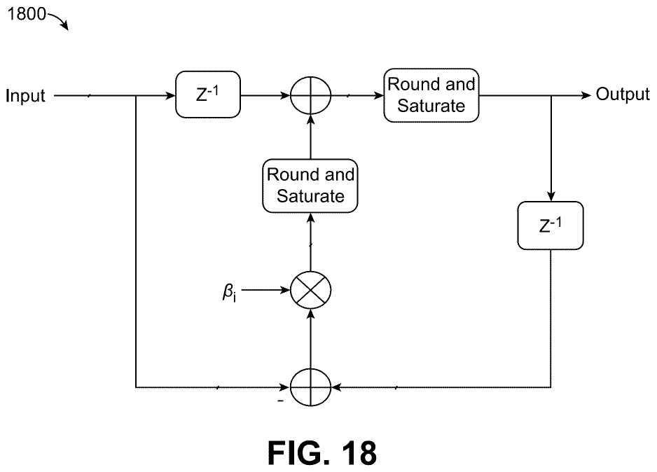

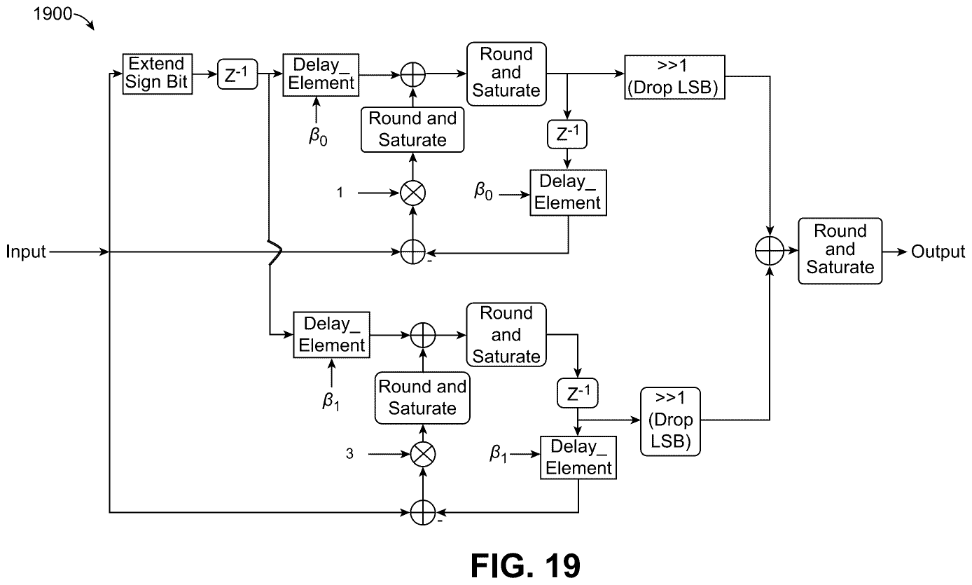

FIG. 18 is a diagram illustrating an example fixed-point implementation 1800 of a delay element, such as the group delay element D_{β}_{ᵢ}(z⁻¹) of FIG. 17, etc. FIG. 19 is a diagram illustrating an example embodiment of the fixed-point implementation of the overall filter (e.g., an example fixed-point implementation of a programmable cut-off IIR filter), in accordance with some examples. As illustrated in FIGS. 18 and 19, the example embodiments of the fixed-point implementations of the delay element and the overall filter, respectively, can be seen to highlight practical considerations for hardware realization.

In some aspects embodiments of the methods and systems disclosed herein is used to provide a scalable and adaptable framework for implementing half-band filters with programmable cut-off frequencies for energy detection in a receiver, as well as to implement a correspond low-pass filter in a transmitter. These embodiments support a wide range of use cases, from communication systems to embedded signal processing applications, demonstrating their value in advancing the state of the art. As contemplated herein, systems and techniques for energy detection can be used to provide a versatile mechanism for enhancing various system functionalities. The following applications described below provide illustrative examples of how the presently disclosed systems and techniques for improved and lower latency energy measurement may be effectively utilized in communication systems, and are not intended to be construed as limiting.

### Example 1. Gating Automatic Gain Control (AGC) Using in-Band Energy

Some embodiments of the disclosed invention can be used to address the adverse impact of large out-of-band (OOB) blockers on receiver performance, which can lead to significant degradation by desensitizing the receiver. To mitigate this issue, embodiments of the invention can be configured to integrate an in-band energy detection mechanism to regulate the operation of an AGC algorithm of the receiver. In particular, the AGC algorithm can be selectively activated and/or deactivated based on the detected power level determined by the in-band energy detection mechanism (e.g., based on the output of the in-band energy detection mechanism using the IIR HB filter(s) described herein, etc.). For instance, when in-band energy is present (e.g., such as when the detected power level exceeds a configured threshold), the AGC is configured to operate to adjust the gain as required. Conversely, in scenarios where in-band energy is absent, for example when the detected power level is below the configured threshold, the systems and techniques can gate the AGC operation. In one embodiment, the AGC is reset and restarted to prevent improper adjustments caused by high-level blockers. This method may be implemented using various energy detection and gating structures, enabling robust AGC performance across diverse receiver architectures. The gating mechanism described herein may include, but is not limited to, analog signal processing circuits, digital logic, or hybrid configurations, as suited to the specific application requirements. This approach ensures improved receiver performance by mitigating the adverse effects of out-of-band interference, enhancing sensitivity, and maintaining stable gain control. One or more aspects of the systems and techniques provided herein may be applied across a variety of wireless communication systems, including but not limited to, cellular receivers, IoT devices, and/or broadband systems, among various others, offering scalability and adaptability to differing operational environments.

### Example 2. Gating Packet Detection

Embodiments of the reduced latency energy detection described herein may additionally or alternatively be used to enhance the reliability and efficiency of packet detection processes in communication systems. For example, the systems and techniques provided herein is configured to may selectively activate a packet detection module only when sufficient in-band energy is detected, thereby reducing the likelihood of false alarms caused by interferences or noise. By gating the packet detection process based on real-time energy measurements, embodiments of the invention can be used to ensure that the packet detection module operates only under relevant signal conditions, thereby minimizing unnecessary triggers and enhancing system reliability. In addition to improving packet detection accuracy, this selective activation mechanism contributes to significant power savings in the receiver. For instance, by avoiding packet detection operations during periods of weak in-band energy, the invention reduces power consumption, making it particularly suitable for low-power and resource-constrained applications. Moreover, this method is adaptable to various receiver architectures where signal integrity and power efficiency are critical.

### Example 3. Early Clear Channel Assessment (CCA) Indication

The rapid responsiveness of in-band energy detection enables early reporting of Clear Channel Assessment (CCA) results to the Media Access Control (MAC) layer. By detecting in-band energy early, the systems and techniques herein can be used to expedite the CCA process, thereby allowing the MAC layer to make faster decisions regarding channel availability and usage. These applications demonstrate the utility of in-band energy measurement in improving system performance, reliability, and efficiency across various operational scenarios.

### Example 4. Performing AGC Based on and or Using in-Band Energy

In some aspects, the analog received signal strength indicator (RSSI) is a hardware feature that measures the strength of signals received by the wireless communication device, and may be configured such that the wireless communication device provides RSSI feedback to the AGC. However, the analog RSSI reacts only for signals stronger than a certain level, for example, −65 dBm. For weaker signals, such as signals between −80 dBm and −65 dBm, the analog RSSI does not provide reliable feedback. Without reliable RSSI feedback, the AGC cannot work effectively for weaker signals, resulting in sub-optimal performance. In an embodiment of the present invention, the rapid responsiveness of in-band energy detection provides techniques for measuring signal strength in substantially real-time, even for weaker signals below the analog RSSI threshold. Accordingly, the detected power level provided in substantially real-time by the systems and techniques described herein can be used by the AGC to adjust the gain of the receiver dynamically and appropriately for signals in the weaker range. This ensures that the AGC remains effective even when the analog RSSI cannot provide meaningful input. The AGC dynamically adjusts the gain to ensure consistent signal levels for subsequent processing, improving the reliability and performance of the system across a wider range of signal strengths.

Moreover, energy detection methods with low-latency capabilities are crucial for enhancing spectrum utilization in the wireless communication systems, especially in licensed and unlicensed frequency bands. These energy detection methods enable wireless communication devices to continuously monitor power levels within the desired frequency band, to identify available channels, avoid interference, and maintain stable connections. In dynamic environment, such as those involving shared or congested spectrum, embodiments of the low latency energy detection ensure that decisions regarding channel usage are made rapidly, reducing the time to respond to changes in the spectrum. Specifically, the low-latency energy detection method may be used to dynamically select the least congested channels and maximize the available bandwidth, prevent transmissions that would interfere with ongoing communications, and enhance overall throughput by reducing retransmissions and delays. These capabilities are essential for both consumer electronics such as smartphones and IoT devices and industrial systems. The low-latency energy detection method enables robust operation in increasing crowded wireless environments by ensuring reliable connectivity.

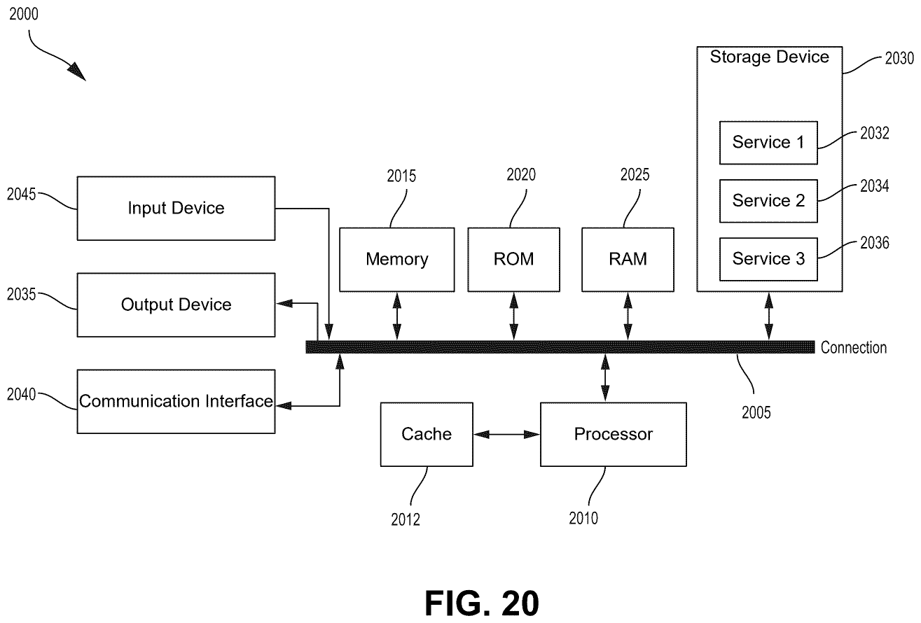

FIG. 20 illustrates a computing device architecture 2000 of a computing device which can implement one or more techniques described herein. In some examples, the computing device can include a mobile device, a wearable device, an extended reality device (e.g., a Virtual Reality (VR) device, an Augmented Reality (AR) device, or a Mixed Reality (MR) device), a personal computer, a laptop computer, a video server, a vehicle (or computing device of a vehicle), or other device. The components of computing device architecture 2000 are shown in electrical communication with each other using connection 2005, such as a bus. The computing device architecture 2000 includes a processing unit 2010 and computing device connection 2005 that couples various computing device components including computing device memory 2015, such as Read Only Memory (ROM) 2020 and Random-Access Memory (RAM) 2025, to processor 2010.

Computing device architecture 2000 can include a cache of high-speed memory connected directly with, in close proximity to, or integrated as part of processor 2010. Computing device architecture 2000 can copy data from memory 2015 and/or the storage device 2030 to cache 2012 for quick access by processor 2010. In this way, the cache can provide a performance boost that avoids processor 2010 delays while waiting for data. These and other engines can control or be configured to control processor 2010 to perform various actions. Other computing device memory 2015 may be available for use as well. Memory 2015 can include multiple different types of memory with different performance characteristics. Processor 2010 can include any general-purpose processor and a hardware or software service, such as service 1 2032, service 2 2034, and service 3 2036 stored in storage device 2030, configured to control processor 2010 as well as a special-purpose processor where software instructions are incorporated into the processor design. Processor 2010 may be a self-contained system, containing multiple cores or processors, a bus, memory controller, cache, etc. A multi-core processor may be symmetric or asymmetric.

To enable user interaction with the computing device architecture 2000, input device 2045 can represent any number of input mechanisms, such as a microphone for speech, a touch-sensitive screen for gesture or graphical input, keyboard, mouse, motion input, speech and so forth. Output device 2035 can also be one or more of a number of output mechanisms known to those of skill in the art, such as a display, projector, television, speaker device, etc. In some instances, multimodal computing devices can enable a user to provide multiple types of input to communicate with computing device architecture 2000. Communication interface 2040 can generally govern and manage the user input and computing device output. There is no restriction on operating on any particular hardware arrangement and therefore the basic features here may easily be substituted for improved hardware or firmware arrangements as they are developed.

Storage device 2030 is a non-volatile memory and can be a hard disk or other types of computer readable media which can store data that are accessible by a computer, such as magnetic cassettes, flash memory cards, solid state memory devices, digital versatile disks, cartridges, RAM, ROM, and hybrids thereof. Storage device 2030 can include services 2032, 2034, 2036 for controlling processor 2010. Other hardware or software modules or engines are contemplated. Storage device 2030 can be connected to the computing device connection 2005. In one aspect, a hardware module that performs a particular function can include the software or processor readable codes stored in a computer-readable medium in connection with the necessary hardware components, such as processor 2010, connection 2005, output device 2035, and so forth, to carry out the function.

The term “device” is not limited to one or a specific number of physical objects (such as one smartphone, one controller, one processing system and so on). As used herein, a device may be any electronic device with one or more parts that may implement at least some portions of this disclosure.

Individual aspects may be described above as a process or method which is depicted as a flowchart or a data flow diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, or a subprogram. When a process corresponds to a function, its termination can correspond to a return of the function to the calling function or the main function.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above.

The program code may be executed by a processor, which may include one or more processors, such as one or more Digital Signal Processors (DSPs), general purpose microprocessors, an Application Specific Integrated Circuits (ASICs), Field Programmable Gate Arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices.

What is claimed is:

1. A method for energy detection by a wireless communication device, the method comprising:
filtering a received signal using a half-band (HB) filter with a configured cut-off frequency to thereby obtain a filtered signal based on the received signal, wherein the HB filter is associated with a receiver of the wireless communication device, and the received signal comprises a wireless transmission received by the receiver;
determining information indicative of a power level corresponding to a detected energy associated with the filtered signal; and
processing, by the wireless communication device, the received signal according to the information indicative of the power level.

2. The method of claim 1, wherein the receiver of the wireless communication device is associated with a receiver downsampling chain comprising a first signal processing path, and the HB filter is included in a second signal processing path different from the first signal processing path and in parallel with at least a portion of the receiver downsampling chain.

3. The method of claim 2, wherein processing the received signal comprises:
processing one or more receiver functions based on the information indicative of the power level before demodulated symbols become available from the receiver downsampling chain.

4. The method of claim 3, wherein processing the one or more receiver functions includes performing clear channel assessment (CCA) based on the information indicative of the power level.

5. The method of claim 2, wherein the second signal processing path comprises an energy detection branch tapped from an output of a compensation filter included in the receiver downsampling chain, and the energy detection branch is in parallel with a receiver decimation chain included in the receiver downsampling chain after the output of the compensation filter.

6. The method of claim 2, wherein:
a first portion of the receiver downsampling chain is before an output of a compensation filter;
a second portion of the receiver downsampling chain is after the output of the compensation filter; and
the second signal processing path is in parallel with the second portion of the receiver downsampling chain.

7. The method of claim 6, wherein the HB filter is associated with a first group delay, and the first group delay is less than a second group delay associated with the second portion of the receiver downsampling chain.

8. The method of claim 1, wherein the HB filter is an Infinite Impulse Response (IIR) HB filter, and an input to the HB filter corresponds to an output of a compensation filter included a receiver downsampling chain of the wireless communication device.

9. The method of claim 8, wherein the IIR HB filter comprises two or more all-pass filter sections with respective configurable parameters based on an attenuation characteristic.

10. The method of claim 9, wherein each all-pass filter section of the two or more all-pass filter sections is associated with a respective input, and the respective input for each all-pass filter section is configured to share a common delay register included in the receiver.

11. The method of claim 1, wherein determining information indicative of the power level comprises calculating an energy metric based on an output of the HB filter corresponding to the filtered signal by:
applying a magnitude approximation and an averaging filter to the filtered signal output of the HB filter; and
calculating the energy metric from an averaged output from the averaging filter.

12. The method of claim 11, wherein the averaging filter comprises:
an exponential averaging filter implemented by a single pole Infinite Impulse Response (IIR) filter; or
one or a combination of an exponential averaging filter and a moving window averaging filter.

13. The method of claim 1, wherein the power level is a measure of in-band energy corresponding the received signal, and processing the received signal according to the information indicative of the power level comprises at least one of:
performing a gating automatic gain control (AGC) reset operation in response to the power level being below a configured threshold; or
performing gating packet detection to avoid false alarms on interferences in response to the power level being below the configured threshold.

14. The method of claim 1, wherein:
the HB filter is a programmable filter configurable between a low-pass filter configuration and a high-pass filter configuration;
the power level is a measure of an in-band energy of the received signal based on the HB filter having the low-pass filter configuration; and
the power level is a measure of an out-of-band energy associated with the received signal based on the HB filter having the high-pass filter configuration.

15. The method of claim 1, further comprising applying a low-pass to low-pass transformation to transform a delay element of an original transfer function of the HB filter to obtain a new all-pass filter section corresponding to a transformed filter function, and the configured cut-off frequency of the HB filter is determined based on the transformed filter function.

16. The method of claim 15, wherein applying the low-pass to low-pass transformation of the HB filter is based on determining corresponding transformation approximation information, and the corresponding transformation approximation information is used to derive a modified transfer function with a reduced number of all-pass filter sections.

17. A wireless communication device in a wireless communication network, the wireless communication device comprising:
a receiver configured to obtain a received signal corresponding to a wireless transmission over the wireless communication network, wherein the receiver includes a receiver downsampling chain configured to perform downsampling of the received signal;
a half-band (HB) filter having a configured cut-off frequency and included in an energy detection branch tapped from an output of a compensation filter of the receiver downsampling chain, wherein the HB filter generates a filtered signal from the output of the compensation filter in parallel with a remaining portion of the receiver downsampling chain after the compensation filter;
an energy meter configured to determine a power level corresponding to the filtered signal obtained from an output of the HB filter; and
a processing module configured to process the received signal according to the power level.

18. The wireless communication device of claim 17, further comprising a digital high pass filter coupled to the output of the compensation filter and the input of the HB filter, wherein the digital high pass filter is configured to remove DC signal components from the output of the compensation filter and provide the DC filtered signal to the input of the HB filter.

19. The wireless communication device of claim 17, wherein the energy meter is configured to determine the power level using an in-band power computation configured to convert the power level from decibel (dB) to an input referred power level in decibel-milliwatts (dBm).

20. The wireless communication device of claim 17, wherein:
the processing module comprises an automatic gain control (AGC), and wherein the AGC is gated and reset adaptively according to the power level, or a gain of the AGC is adjusted according to the power level; or
the processing module comprises a packet detection module, and the packet detection module is adaptively gated according to the power level; or
the processing module comprises a medium access control (MAC) processor, and the power level is used to perform a clear channel assessment (CCA) for reporting by the wireless communication device.
